(19) United States
(12) Patent Application Publication
(10) Pub. No.: US 2026/0201237 A1
(43) Pub. Date: Jul. 16, 2026

(54) THERMALLY CONDUCTIVE DIELECTRIC COATINGS

(71) Applicant: Henkel AG & Co. KGaA, Duesseldorf (DE)

(72) Inventors: Libin Du, Troy, MI (US); John D. McGee, Troy, MI (US); Gregory T. Donaldson, Sterling Heights, MI (US); Michael A. Murphy, JR., Armada, MI (US); Lisa K. Miller, Clinton Township, MI (US)

(21) Appl. No.: 19/561,989

(22) Filed: Mar. 10, 2026

Related U.S. Application Data
(63) Continuation of application No. PCT/US2024/046874, filed on Sep. 16, 2024.
(60) Provisional application No. 63/584,660, filed on Sep. 22, 2023.

(51) Int. Cl. C09K 5/14; B65D 65/42; C09D 4/00; C09D 5/18; C09D 7/61; C09D 135/02; C09D 167/06; F26B 3/28; H01B 3/42; H01M 10/6551

(52) U.S. Cl. CPC C09K 5/14; B65D 65/42; C09D 4/00; C09D 5/18; C09D 7/61; C09D 135/02; C09D 167/06; H01B 3/421; H01M 10/6551; F26B 3/28

(57) ABSTRACT

A curable liquid coating composition sprayable onto a substrate thereby forming a thin, pin-hole free, thermally conductive dielectric coating exhibiting a combination of improved dielectric strength along with improved thermal conductivity, wherein the composition comprises organic resin, reactive diluent, thermally conductive filler, dispersing agent, initiator, and an additive selected from organic solvent, accelerator and rheology modifier; also provided are methods of producing the compositions, coatings, and substrates comprising curable or cured thermally conductive dielectric coating layers, as well as articles comprising curable or cured coating layers of the composition.

### TECHNICAL FIELD

The present invention relates to a curable liquid coating composition useful in depositing a thermally conductive dielectric coating on a substrate, intermediates comprising a substrate having a layer of curable, optionally dried, coating composition deposited thereon, an adherent layer of cured thermally conductive dielectric coating composition on a substrate, coated substrates and methods of producing the compositions, coatings, coating layers and coated substrates.

### BACKGROUND

Electrical components are often electrically insulated by application of high dielectric strength materials. While dielectric materials provide electrical insulation, they often do not facilitate heat dissipation and may be heat insulating. Faster heat dissipation from battery operation is highly desirable in many electrical components, particularly for vehicle OEMs to improve driving range of battery powered vehicles and longevity of battery packs. The usual electrical battery insulation in such vehicles is mainly through applying powder coats or using plastic insulating wraps or films; neither of these adequately address heat dissipation needs. Powder coats have the downside of requiring high temperatures for curing, e.g. 175-205° C. for 10-15 min. plus ramp time for the part to reach cure temperature. (approx. 30 min.). Powder coats are in general thick and take multiple coats to ensure pinhole-free films. Powder coats, therefore, have additional downsides of undesirably increasing weight and high thermal impedance, while plastic wraps require complex handling and processing for installation, and long term reliability and risk of delamination are concerns.

Thus it is desirable to develop dielectric coatings that facilitate heat dissipation, particularly for battery cooling systems, prismatic cells, cold plates, power inverters, busbars and chargers. It is also desirable to develop improved dielectric coatings that provide good electrical insulation at low film thicknesses for weight reduction, which are applied by less complex processes and use less time and energy. Therefore, there is a need for a thermally conductive dielectric coating that can be applied defect-free at thinner coating thicknesses than previously available for use in vehicles, the thermally conductive coating having a combination of improved dielectric strength along with improved thermal conductivity or low thermal resistance.

### SUMMARY

The curable liquid coating compositions, substrates having a layer of curable, optionally dried, coating composition deposited thereon and cured polymeric thermally conductive dielectric coating layers on a substrate and coated substrates according to aspects of the invention solve one or more of the above described disadvantages or needs, and exhibit high dielectric strength, thermal dissipation and good electrical insulation, as further described herein.

Various embodiments of the curable liquid coating composition may comprise or consist essentially of or consist of: organic resin, e.g. polyester resin, reactive diluent, thermally conductive filler, dispersing agent, initiator, and an additive selected from organic solvent, accelerator, rheology modifier optionally surface modified (also referred to herein as a thixotropic agent). Optionally, such compositions may also contain additives such as a de-aerator, coupling agents, anti-foaming agent, pigments and dyes, plasticizers, flexibilizers, flame retardants, impact modifiers/toughening agents, fillers, flow control agents, adhesion promoters, inhibitors, antioxidants, non-reactive diluents, extenders or other adjuvants. In certain Embodiments, the curable liquid coating composition is free of formaldehyde.

Various embodiments of the invention are described throughout this disclosure, including:

Embodiment 1. A curable liquid coating composition comprising:
(a) a polyester resin;
(b) a reactive diluent;
(c) a thermally conductive filler;
(d) a dispersing agent;
(e) an initiator; and
(f) optionally an accelerator, different from the initiator;
   wherein the polyester resin is selected from unsaturated polyester resins, which may desirably comprise vinyl ester resins, preferably comprising epoxy vinyl esters such as epoxy acrylate esters and epoxy methacrylate esters, and combinations thereof.

The curable liquid coating composition may further comprise at least one additive preferably selected from the group consisting of, organic solvent, accelerator, rheology modifier that optionally may be surface modified (also referred to herein as a thixotropic agent). The curable liquid coating composition may also contain de-aerator, coupling agents, anti-foaming agent, pigments and dyes, plasticizers, flexibilizers, flame retardants, impact modifiers/toughening agents, additional filler different from (c), flow control agents, adhesion promoters, inhibitors, antioxidants, non-reactive diluents, extenders or other adjuvants. In certain Aspects of this Embodiment, the curable liquid composition is free of formaldehyde.

Embodiment 2. The curable liquid coating composition of Embodiment 1 further characterized in that said components are or comprise, the following given in wt. %:
(a) one or more unsaturated polyester resins, desirably vinyl ester resins, preferably epoxy vinyl ester resins, such as epoxy acrylate esters and epoxy methacrylate esters, and combinations thereof, desirably present in a range of from 10% to 95%, preferably 25% to 50%;
(b) a radical reactive diluent, desirably present in a range of from 10% to 95%, preferably 25% to 50%;
(c) a thermally conductive filler such as boron nitride, alumina, aluminum trihydrate, desirably present in a range of from 5% to 50%, preferably 10% to 30%;
(d) a dispersing agent, desirably present in a range of from 0.1% to 2.0%
(e) an initiator, desirably present in a range of from 0.1% to 5%;
(f) an accelerator, different from the initiator, desirably present in a range of from 0% to 1%;
(g) an organic solvent, desirably present in a range of from 0.5% to 20%;
(h) at least one additive selected from a rheology modifier, an adhesion promoter, a flexibilizer, and a plasticizer, each desirably present in a range of from 0% to 5%
(i) a de-aerator and/or an anti-foaming agent, desirably present in a range of from 0% to 2.0%;
   wherein the wt. % of each component is relative to the total weight of the composition and the total amount of the components does not exceed 100 wt. %.

Embodiment 3. The curable liquid coating composition of any one of the above-disclosed Embodiments, wherein (a) the unsaturated polyester resins, desirably vinyl ester resins, preferably epoxy vinyl ester resins, such as epoxy acrylate esters and epoxy methacrylate esters, and combinations thereof, is present in a range of from 10 wt. % to 15 wt. %, from 15 wt. % to 20 wt. %, from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, from 50 wt. % to 55 wt. %, from 55 wt. % to 60 wt. % from 60 wt. % to 65 wt. %, from 65 wt. % to 70 wt. %, from 70 wt. % to 75 wt. %, from 75 wt. % to 80 wt. %, from 80 wt. % to 85 wt. %, from 85% to 90%; from 90% to 95%, or any combination of two or more of the foregoing ranges, for example from 25 wt. % to 50 wt. %, or any of the foregoing values, relative to the total weight of the composition.

Embodiment 4. The curable liquid coating composition of any one of the above-disclosed Embodiments, wherein (b) the radical reactive diluent, is present in a range of from 10 wt. % to 15 wt. %, from 15 wt. % to 20 wt. %, from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, from 50 wt. % to 55 wt. %, from 55 wt. % to 60 wt. % from 60 wt. % to 65 wt. %, from 65 wt. % to 70 wt. %, from 70 wt. % to 75 wt. %, from 75 wt. % to 80 wt. %, from 80 wt. % to 85 wt. %, from 85% to 90%; from 90% to 95%, or any combination of two or more of the foregoing ranges, for example from 25 wt. % to 50 wt. %, or any of the foregoing values, relative to the total weight of the composition.

Embodiment 5. The curable liquid coating composition of any one of the above-disclosed Embodiments, wherein (c) the thermally conductive filler, preferably comprising boron nitride filler, is present in a range of from 5 wt. % to 10%, from 10 wt. % to 15 wt. %, from 15 wt. % to 20 wt. %, from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, or any combination of two or more of the foregoing ranges, for example from 10 wt. % to 30 wt. %, or any of the foregoing values, relative to the total weight of the composition.

Embodiment 6 The curable liquid coating composition any one of the above-disclosed Embodiments, wherein (d) the dispersing agent, is present in a range of from 0.1 wt. % to 0.2 wt. %, 0.2 wt. % to 0.3 wt. %, from 0.3 wt. % to 0.4 wt. %, from 0.4 wt. % to 0.5 wt. %, from 0.5 wt. % to 0.6 wt. %, from 0.6% to 0.7 wt. %, from 0.7 wt. % to 0.8 wt. %, from 0.8 wt. % to 0.9 wt. %, from 0.9 wt. % to 1.0 wt. %, from 1.0 wt. % to 1.1 wt. %, from 1.1 wt. % to 1.2 wt. %, from 1.2 wt. % to 1.3 wt. %, 1.3 wt. % to 1.4 wt. %, from 1.4 wt. % to 1.5 wt. %, from 1.5 wt. % to 1.6 wt. %, from 1.6 wt. % to 1.7 wt. %, from 1.7 wt. % to 1.8 wt. %, from 1.8 wt. % to 1.9 wt. %, from 1.9 wt. % to 2.0 wt. %, or any combination of two or more of the foregoing ranges, for example from 0.5 wt. % to 1.2 wt. %, or any of the foregoing values, relative to the total weight of the composition.

Embodiment 7. The curable liquid coating composition of any one of the above-disclosed Embodiments, wherein (e) the initiator is present, independently in increasing order of preference, in an amount of at least about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, or 1.9 wt. %, and independently in increasing order of preference, in an amount of not more than about, 6.0 wt. %, 5.5 wt. %, 5.25 wt. %, 5.0 wt. %, 4.9 wt. %, 4.8 wt. %, 4.7 wt. %, 4.6 wt. %, 4.5 wt. %, 4.4 wt. %, 4.3 wt. %, 4.2 wt. %, 4.1 wt. %, 4.0 wt. %, 3.9 wt. %, 3.8 wt. %, 3.7 wt. %, 3.6 wt. %, 3.5 wt. %, 3.4 wt. %, 3.3 wt. %, 3.2 wt. %, 3.1 wt. %, 3.0 wt. %, 2.9 wt. %, 2.8 wt. %, 2.7 wt. %, 2.6 wt. %, 2.5 wt. %, 2.4 wt. %, 2.3 wt. %, 2.2 wt. %, 2.1 wt. %, 2.0 wt. % or 1.95 wt. %, relative to the total weight of the composition.

Embodiment 8. The curable liquid coating composition of any one of the above-disclosed Embodiments, wherein (f) the accelerator, different from the initiator, is present, independently in increasing order of preference, in an amount of at least about 0.01 wt. %, 0.02 wt. %, 0.02 wt. % to 0.03 wt. %, from 0.03 wt. % to 0.04 wt. %, from 0.04 wt. % to 0.05 wt. %, from 0.05 wt. % to 0.06 wt. %, from 0.06% to 0.07 wt. %, from 0.07 wt. % to 0.08 wt. %, from 0.08 wt. % to 0.09 wt. %, from 0.09 wt. % to 0.10 wt. %, and independently in increasing order of preference, in an amount of not more than about, 3.0 wt. %, 2.9 wt. %, 2.8 wt. %, 2.7 wt. %, 2.6 wt. %, 2.5 wt. %, 2.4 wt. %, 2.3 wt. %, 2.2 wt. %, 2.1 wt. %, 2.0 wt. %, 1.9 wt. %, 1.8 wt. %, 1.7 wt. %, 1.6 wt. %, 1.5 wt. %, 1.4 wt. %, 1.3 wt. %, 1.2 wt. %, 1.1 wt. %, 1.0 wt. %, 0.9 wt. %, 0.8 wt. %, 0.7 wt. %, 0.6 wt. %, 0.5 wt. %, 0.4 wt. %, 0.3 wt. %, 0.2 wt. %, 0.175 wt. %, 0.15 wt. %, or any combination of two or more of the foregoing ranges, for example from 0.3 wt. % to 0.8 wt. %, or any of the foregoing values, relative to the total weight of the composition.

Embodiment 9. The curable liquid coating composition of any one of the above-disclosed Embodiments, wherein (g) the organic solvent, is present in a range of from 0.5 to 1 wt. %, from 1 wt. % to 2 wt. %, from 2 wt. % to 3 wt. %, from 3 wt. % to 4 wt. %, from 4 wt. % to 5 wt. %, from 5 wt. % to 6 wt. %, from 6% to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, or any combination of two or more of the foregoing ranges, for example from 0.5 wt. % to 1.2 wt. %, or any of the foregoing values, relative to the total weight of the composition.

Embodiment 10. The curable liquid coating composition of any one of the above-disclosed Embodiments, wherein (h) the additive is present in an amount ranging from 0.1 wt. % to 0.2 wt. %, 0.2 wt. % to 0.3 wt. %, from 0.3 wt. % to 0.4 wt. %, from 0.4 wt. % to 0.5 wt. %, from 0.5 wt. % to 0.6 wt. %, from 0.6% to 0.7 wt. %, from 0.7 wt. % to 0.8 wt. %, from 0.8 wt. % to 0.9 wt. %, from 0.9 wt. % to 1.0 wt. %, from 1.0 wt. % to 1.1 wt. %, from 1.1 wt. % to 1.2 wt. %, from 1.2 wt. % to 1.3 wt. %, 1.3 wt. % to 1.4 wt. %, from 1.4 wt. % to 1.5 wt. %, from 1.5 wt. % to 1.6 wt. %, from 1.6 wt. % to 1.7 wt. %, from 1.7 wt. % to 1.8 wt. %, from 1.8 wt. % to 1.9 wt. %, from 1.9 wt. % to 2.0 wt. % from 2.1 wt. % to 2.2 wt. %, from 2.2 wt. % to 2.3 wt. %, 2.3 wt. % to 2.4 wt. %, from 2.4 wt. % to 2.5 wt. %, from 2.5 wt. % to 2.6 wt. %, from 2.6 wt. % to 2.7 wt. %, from 2.7 wt. % to 2.8 wt. %, from 2.8 wt. % to 2.9 wt. %, from 2.9 wt. % to 3.0 wt. % from 3.1 wt. % to 3.2 wt. %, from 3.2 wt. % to 3.3 wt. %, 3.3 wt. % to 3.4 wt. %, from 3.4 wt. % to 3.5 wt. %, from 3.5 wt. % to 3.6 wt. %, from 3.6 wt. % to 3.7 wt. %, from 3.7 wt. % to 3.8 wt. %, from 3.8 wt. % to 3.9 wt. %, from 3.9 wt. % to 4.0 wt. %, from 4.0 wt. % to 4.1 wt. %, 4.1 wt. % to 4.2 wt. %, from 4.2 wt. % to 4.3 wt. %, 4.3 wt. % to 4.4 wt. %, from 4.4 wt. % to 4.5 wt. %, from 4.5 wt. % to 4.6 wt. %, from 4.6 wt. % to 4.7 wt. %, from 4.7 wt. % to 4.8 wt. %, from 4.8 wt. % to 4.9 wt. %, from 4.9 wt. % to 5.0 wt. % or any combination of two or more of the foregoing ranges, for example from 0.3 wt. % to 0.7 wt. %, or any of the foregoing values, relative to the total weight of the composition.

Embodiment 11. The curable liquid coating composition of Embodiment 10, wherein the additive comprises the rheology modifier present of any one of the above-disclosed Embodiments in a range of from 0.05% to 5%.

Embodiment 12. The curable liquid curable coating composition of any one of the above-disclosed Embodiments, wherein (i) the de-aerator and/or an anti-foaming agent, are each present in a range of from 0.1 wt. % to 0.2 wt. %, 0.2 wt. % to 0.3 wt. %, from 0.3 wt. % to 0.4 wt. %, from 0.4 wt. % to 0.5 wt. %, from 0.5 wt. % to 0.6 wt. %, from 0.6% to 0.7 wt. %, from 0.7 wt. % to 0.8 wt. %, from 0.8 wt. % to 0.9 wt. %, from 0.9 wt. % to 1.0 wt. %, from 1.0 wt. % to 1.1 wt. %, from 1.1 wt. % to 1.2 wt. %, from 1.2 wt. % to 1.3 wt. %, 1.3 wt. % to 1.4 wt. %, from 1.4 wt. % to 1.5 wt. %, from 1.5 wt. % to 1.6 wt. %, from 1.6 wt. % to 1.7 wt. %, from 1.7 wt. % to 1.8 wt. %, from 1.8 wt. % to 1.9 wt. %, from 1.9 wt. % to 2.0 wt. % or any combination of two or more of the foregoing ranges, for example from 0.3 wt. % to 0.7 wt. %, or any of the foregoing values, relative to the total weight of the composition.

For a variety of reasons, it is preferred that curable liquid coating compositions, uncured layers of as-deposited coating compositions, optionally dried; and cured thermally conductive dielectric coatings disclosed herein may be made in the absence of certain ingredients, i.e. be free of certain materials, whether added or generated in situ, other than minor amounts of contaminants; or may be substantially free from certain ingredients used for similar purposes in the prior art. Specifically, it is increasingly preferred in the order given, independently for each preferably minimized ingredient listed below, that at least some embodiments according to the invention contain no more than 1.0, 0.5, 0.35, 0.10, 0.08, 0.04, 0.02, 0.01, 0.001, or 0.0002 percent, more preferably said numerical values in grams per liter, more preferably said numerical values in ppm, of each of the following constituents: free Bisphenol A, halogenated epoxy resins, nonylphenol, toluene, xylene, copper, gold, silver, oxidizing agents such as peroxides and peroxyacids, permanganate, perchlorate, chlorate, chlorite, hypochlorite, perborate, hexavalent chromium, sulfuric acid and sulfate, nitric acid and nitrate ions; as well as fluorine, formaldehyde, formamide, hydroxylamines, cyanides, cyanates; solid particles of a polymer/boron nitride composite, such as thermoset polymer/BN particles and/or thermoplastic polymer/BN particles; dissolved or soluble boron species, e.g. borax, borate; strontium; and/or free halogen ions, e.g., fluoride, chloride, bromide or iodide.

As used herein, “dielectric coating” refers to a coating that is electrically insulating. As will be described in further detail herein, the dielectric coating of embodiments of the present invention remains electrically insulating, i.e. conducts little, preferably no electricity, at a dielectric withstand voltage of at least 2.0 kV, desirably greater than 2.0 kV, desirably greater than 3.0 kV, preferably greater than 4.0 kV, most preferably greater than 5 kV, as measured by a HypotMAX 7720 or an Ikonix 3865 and in accordance with ASTM D 149-09 Hipot test.

As used herein, the term “polymer” refers to oligomers (The IUPAC 1.2 (1996) definition describes an oligomer as a molecule that “has properties which vary significantly with the removal of one or a few of the units). For clarity, embodiments of oligomers described herein desirably have greater than in increasing order of preference about 3, 4, 5 or 6 up to about 500 100, 50, 25, 15, 10 monomer units or MW of at least 500 750, 800, 900 or 1000 Dalton, preferably less than 5000, 4000, 3000 or 2000 Dalton), homopolymers (e.g., prepared from a single monomer species), copolymers (e.g., prepared from at least two monomer species), as well as graft polymers. The term “resin” is used interchangeably with “polymer.” Further, the term “crosslinker” refers to a molecule comprising two or more functional groups that are reactive with other functional groups, typically present on polymers, and which is capable of linking two or more polymer molecules through chemical bonds.

The transitional terms “comprising,” “consisting essentially of,” and “consisting of” are intended to connote their generally accepted meanings in the patent lexicon; for those embodiments provided in terms of “consisting essentially of,” the basic and novel characteristic(s) is the facile operability of the methods or compositions/systems to provide compositions as exhibiting the claimed functional features using only those components listed.

In the present disclosure the singular forms “a”, “an”, and “the” include the plural reference, and reference to a particular numerical value includes at least that particular value, unless the context clearly indicates otherwise. Thus, for example, a reference to “a compound” is a reference to one or more of such compounds and equivalents thereof known to those skilled in the art, and so forth. Furthermore, when indicating that a certain chemical moiety “may be” X, Y, or Z, it is not necessarily intended by such usage to exclude other choices for the moiety; for example, a statement to the effect that a moiety “may be alkyl, aryl, or amino” does not necessarily exclude other choices for the moiety, such as halo, aralkyl, and the like.

Throughout the description, unless expressly stated to the contrary: percent, “parts of”, and ratio values are by weight or mass; molecular weight (MW) is weight average molecular weight unless otherwise specified; the word “mole” means “gram mole”, and the word itself and all of its grammatical variations may be used for any chemical species defined by all of the types and numbers of atoms present in it, irrespective of whether the species is ionic, neutral, unstable, hypothetical or in fact a stable neutral substance with well-defined molecules.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment, combinable with others.

Other than in the operating examples, or where otherwise indicated, all numbers expressing quantities of ingredients, reaction conditions, or defining ingredient parameters used herein are to be understood as modified in all instances by the term “about”. When values are expressed as approximations, by use of the antecedent “about,” it will be understood that the particular value forms another embodiment. As used herein, “about X” (where X is a numerical value) preferably refers to +10% of the recited value, inclusive. Also, when the term “about” precedes a range, it is understood that the term modifies both recited endpoints and all points embraced within the range. For example, the phrase “about 1-10” is understood to mean “about 1 to about 10”, as well as “about x”, wherein x refers to any value between 1 and 10. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” In another example, when a listing of possible choices for a moiety including “hydrogen, alkyl, and aryl” is provided, the recited listing may be construed as including situations whereby any of “hydrogen, alkyl, and aryl” is negatively excluded; thus, a recitation of “hydrogen, alkyl, and aryl” may be construed as “hydrogen and aryl, but not alkyl”, or simply “wherein the moiety is not alkyl”.

This section provides a general summary of the disclosure and is not a comprehensive disclosure of its full scope or all features, aspects or objectives. These and other features and advantages of this disclosure will become more apparent to those skilled in the art from the detailed description of a preferred embodiment. The drawings that accompany the detailed description are described below.

### BRIEF DESCRIPTION OF THE DRAWINGS

FIG. 1 shows a Field Emission Scanning Electron Microscope (FESEM) image of a cross-section of a corner portion of a panel sample taken from an Aluminum 3003 alloy battery cell container, often referred to as a prismatic cell box, showing the metal of the container, a cured thermally conductive dielectric coating adhered thereto and indicators of measured thickness of the cured coating at the corner portion.

FIG. 2 shows a Field Emission Scanning Electron Microscope (FESEM) image of a cross-section of the left end portion of the panel sample of FIG. 1, showing the metal of the container, a cured thermally conductive dielectric coating adhered thereto and indicators of measured thickness of the cured coating at the left end portion.

FIG. 3 shows a Field Emission Scanning Electron Microscope (FESEM) image of a cross-section of the left middle portion of the panel sample of FIG. 1, showing the metal of the container, a cured thermally conductive dielectric coating adhered thereto and indicators of measured thickness of the cured coating at the left middle portion.

FIG. 4 shows a Field Emission Scanning Electron Microscope (FESEM) image of a cross-section of the right end portion of the panel sample of FIG. 1, showing the metal of the container, a cured thermally conductive dielectric coating adhered thereto and indicators of measured thickness of the cured coating at the right end portion.

FIG. 5 shows a Field Emission Scanning Electron Microscope (FESEM) image of a cross-section of the right middle portion of the panel sample of FIG. 1, showing the metal of the container, a cured thermally conductive dielectric coating adhered thereto and indicators of measured thickness of the cured coating at the right middle portion.

### DETAILED DESCRIPTION OF ILLUSTRATIVE EMBODIMENTS

The present disclosure may be understood more readily by reference to the following description taken in connection with the accompanying Summary, Figures and Examples, all of which form a part of this disclosure. For purposes of the following detailed description, it is to be understood that the invention may assume various alternative variations and step sequences, except where expressly specified to the contrary. It is to be understood that this invention is not limited to the specific products, methods, conditions or parameters described and/or shown herein, and that the terminology used herein is for the purpose of describing particular embodiments by way of example only and is not intended to be limiting of the claimed invention.

The invention as described herein provides improved dielectric coatings that facilitate heat dissipation, particularly for vehicle battery systems. The cured thermally conductive dielectric coatings according to the invention provide good electrical insulation at low film thicknesses for weight reduction. The chemistry of the coating composition provides a coating with better heat dissipation than other dielectric coatings at similar coating weights. The cured coating constitution and low film thickness work synergistically to better transfer heat away from the substrate and dissipate it.

Deposition methods for the dielectric coatings are also better suited to mass production lines, being applied by less complex processes and using less time and energy, for example by spraying and/or printing.

As discussed above, an embodiment of the invention is a curable liquid coating composition comprising:
(a) a polyester resin;
(b) a reactive diluent;
(c) a thermally conductive filler;
(d) a dispersing agent;
(e) an initiator; and
(f) optionally an accelerator different from the initiator;
   wherein the polyester resin may comprise unsaturated polyester resins, desirably vinyl ester resins, preferably epoxy vinyl ester resins, such as epoxy acrylate esters and epoxy methacrylate esters, and combinations thereof.

Further description of embodiments and components of the invention is provided below.

### Polyester Resins

In general, a variety of polyester resins, preferably having one, two or more sites of unsaturation, are suitable as (a) polyester resins for the compositions of this invention. Non limiting examples include unsaturated polyester resins, such as vinyl ester resins; desirable unsaturated polyester resins include epoxy vinyl esters such as epoxy acrylate esters and epoxy methacrylate esters and the like. These resins have one or more sites of ethylenic unsaturation, preferably having at least about two C═C functional groups per molecule, and may have other functional groups. Some suitable polyester resins may have an acid number of about 0-50, 7-35 or 14-20 mg KOH/g.

Representative unsaturated polyester resins are described in U.S. Pat. Nos. 4,742,121, 5,567,767, 5,571,863, 5,688,867, 5,777,053, 5,874,503 and 6,063,864 and in PCT Published Application Nos. WO 94/07674 A1, WO 00/23495 A1 and WO 03/101918 A2, incorporated herein by reference.

The polyester resin may be prepared from the condensation of one or more carboxylic acids (such as mono, di- or poly-functional unsaturated or saturated carboxylic acids) or their derivatives (such as acid anhydrides, C, alkyl esters, etc.) with one or more alcohols (including mono-functional, di-functional and poly-functional alcohols). The carboxylic acid or derivative may for example be a mixture of an unsaturated carboxylic acid or derivative and a saturated carboxylic acid or derivative.

The unsaturated carboxylic acids or their derivatives may for example have about 3 to about 12, about 3 to about 8, or about 4 to about 6 carbon atoms. Representative unsaturated carboxylic acids and their derivatives include maleic acid, fumaric acid, chloromaleic acid, itaconic acid, citraconic acid, methylene glutaric acid, mesaconic acid, acrylic acid, methacrylic acid, and esters or anhydrides thereof. Desirably unsaturated carboxylic acids and their derivatives include maleic, fumaric acids, fumaric esters and anhydrides thereof. An unsaturated carboxylic acid or its derivative may for example be present in an amount from about 20 to about 90 mole percent, about 35 to about 75 mole percent, or about 50 to about 65 mole percent of the acids or acid derivatives used to make the unsaturated polyester resin. The saturated carboxylic acids and their derivatives may for example have from about 8 to about 18, about 8 to about 15, or about 8 to about 12 carbon atoms. Representative saturated carboxylic acids and their derivatives may be aromatic, aliphatic or a combination thereof, and include succinic acid, glutaric acid, d-methylglutaric acid, adipic acid, sebacic acid, pimelic acid, phthalic anhydride, o-phthalic acid, isophthalic acid, terephthalic acid, dihydrophthalic acid, tetrahydrophthalic acid, hexahydrophthalic acid or anhydride, tetrachlorophthalic acid, chlorendic acid or anhydride, dodecanedicarboxylic acids, nadic anhydride, cis-5-norbomene-2,3-dicarboxylic acid or anhydride, dimethyl-2,6-naphthenic dicarboxylate, dimethyl-2,6-naphthenic dicarboxylic acid, naphthenic dicarboxylic acid or anhydride and 1,4-cyclohexane dicarboxylic acid. Other representative carboxylic acids include ethylhexanoic acid, propionic acid, benzene-1,2,4-tricarboxylic acid, benzoic acid, 1,2,4-benzenetricarboxylic acid, 1,2,4,5-benzenetetracarboxylic acid and anhydrides thereof. Representative aromatic saturated carboxylic acids include o-phthalic acid, isophthalic acid and their derivatives. Representative aliphatic saturated carboxylic acids include 1,4-cyclohexane dicarboxylic acid, hexahydrophthalic acid, adipic acid and their derivatives. The saturated carboxylic acids or their derivatives may for example be present in an amount from about 10 to about 80 mole percent, about 25 to about 65 mole percent, or about 35 to about 50 mole percent of the acids or acid derivatives used to make the unsaturated polyester resin. Also, an aromatic carboxylic acid may for example be present in an amount from 0 to 100 percent, from 0 to about 50 percent, or from 0 to about 25 percent of the saturated acids or acid derivatives used to make the unsaturated polyester resin, and an aliphatic carboxylic acid may for example be present in an amount from 0 to 100 percent, from about 50 to 100 percent, or from about 75 to 100 percent of the saturated acids or acid derivatives used to make the unsaturated polyester resin.

Representative alcohols for use in making the unsaturated polyester resins include alkanediols and oxaalkanediols such as ethylene glycol, 1,2-propylene glycol, propane-3-diol, 1,3-butylene glycol, butene-1,4-diol, hexane-1,6-diol, diethylene glycol, triethylene glycol, polyethylene glycol, cyclohexane-1,2-diol, 2,2-bis-(p-hydroxycyclohexyl)-propane, 5-norbornene-2,2-dimethylol, 2,3-norbornene diol, cyclohexane dimethanol, and the like. Alcohols having a neo-structure such as 1,2-propanediol, 2-methyl 1,3-propanediol, 2,2-dimethyl heptanediol, 2,2-dimethyl octanediol, 2,2-dimethyl-1,3-propanediol (aka, neopentyl glycol), pentaerythritol, dipentaerythritol, tripentaerythritol, trimethylol propane, di-trimethylol propane, 2,2,4-trimethyl-1,3-pentanediol,2-butyl-2-ethyl-1,3-propanediol, 3-hydroxy-2,2-dimethylpropyl3-hydroxy-2,2-dimetphyrolpanate, and the like may be preferred. Monofunctional alcohols may also be used to prepare the unsaturated polyester resin. Representative monofunctional alcohols include benzyl alcohol, cyclohexanol, 2-ethylhexyl alcohol, 2-cyclohexyl ethanol, 2,2-dimethyl-1-propanol and lauryl alcohol. Where a monofunctional alcohol is used, the amount may for example be less than about 10 mole percent, or less than about 5 mole percent of the alcohols used to make the unsaturated polyester resin.

The unsaturated polyester resin may be prepared by esterification techniques catalysts (e.g., esterification or transesterification catalysts) that will be familiar to those skilled in the art. The esterification process is typically carried out until the polyester attains an acid number corresponding to the desired molecular weight. For example, the final acid number may be from about 7 to about 30, the number average molecular weight (Mn) may be from about 800 to about 3600, and the weight average molecular weight (Mw) may be from about 1,300 to about 11,000. The acid number may be reduced by increasing the reaction temperature, carrying out the reaction for a longer period of time, or by adding an acid neutralizer as will be familiar to those skilled in the art.

The unsaturated polyester resin may also be formed by reacting an oligoester, i.e. an ester oligomer chain containing a small number of repeating ester units, having a weight average molecular weight of about 200 to about 4000 with a diisocyanate and a hydroxyalkyl (meth)acrylate to provide a urethane acrylate having terminal vinyl groups, as described in WO2006091446A1. The urethane acrylate resin may be used as is, or in a mixture with another unsaturated polyester resin such as an aliphatic or aromatic unsaturated polyester resin.

In certain embodiments, unsaturated polyester resins are reacted with reactive diluent, such as styrene monomers, using a free radical initiator. The double bonds on the polyester as well as the pendent double bond on the styrene diluent provide pathways for both chain extension and crosslinking.

Epoxy vinyl esters useful in the invention are typically derived from an epoxy resin where the oxirane group has been reacted to generate a functional group having a pendant double bond. Desirably, the modification of the epoxy resin is achieved through the reaction of the oxirane group with alpha-beta unsaturation, for example an acrylate, thereby producing an acrylic (double bond) end group. For example, a Bisphenol A may be reacted with methacrylic acid to form an epoxy methacrylate ester.

Examples of suitable epoxy resins include Bisphenol A epoxy, cycloaliphatic epoxy, epoxy novolac, and epoxy cresol novolac.

Typically, the vinyl ester resin composition may be prepared by dissolving the vinyl ester in a suitable compatible diluent to facilitate handling, cure and to provide excellent mechanical properties. Such compatible diluents may include, for instance, styrene, chlorostyrene, vinyl toluene, α-methyl styrene, diallyl phthalate, triallyl cyanurate, acrylate and methacrylate esters, for example Bisphenol A epoxy diacrylate and trimethylpropane triacrylate, and divinyl benzene. Styrene and mono-, di- and tri-(meth)acrylate esters are preferred compatible diluent. The resin, however, may also be dissolved in a non-reactive diluent, such as, for instance, acetone where low application viscosity is required but where properties obtainable only with the neat resin are desired.

The vinyl ester resins of the present invention are well known in the art and may be prepared by an addition reaction between ethylenically unsaturated monocarboxylic acids and epoxy resins having multiple oxirane groups reactive with the acid as well as an R group which does not participate in the reaction, R may be selected from, for instance, alkylene, cycloalkylene, arylene, arylalkylene, oxyarylene, oxyarylalkylene and cycloalkylene ester. Processes for preparing vinyl ester resins useful in the present invention include those disclosed in U.S. Pat. No. 3,256,226 to Fekete et al., and U.S. Pat. No. 3,317,465 to Doyle et al., U.S. Pat. No. 3,345,401 to May; U.S. Pat. No. 3,373,221 to May; U.S. Pat. No. 3,377,406 to Newey; and U.S. Pat. No. 3,432,478 to May.; U.S. Pat. No. 3,548,030 to Jernigan; and U.S. Pat. No. 3,564,074 to Swisher et al.; U.S. Pat. No. 3,634,542 to Dowd et al.; and U.S. Pat. No. 3,637,618 to May, incorporated herein by reference.

Generally, the vinyl ester resins of the present invention are prepared using suitable catalysts, such as for instance, tertiary amines, phosphines, alkalis or -onium salts. Suitable components of several vinyl ester resins include but are not limited to Bisphenol A epoxy, novolac epoxy and the like reacted with unsaturated acids such as acrylic and methacrylic acid and derivatives thereof.

Increased variety of vinyl ester resins may be obtained by selecting the unsaturated monomer diluents, as described below, which can be combined with and copolymerized with the vinyl ester resin. Preferred vinyl ester resins useful in the present invention are the bisphenol-A (BPA)-epoxy based vinyl ester resins. These resins may be employed in the resin compositions of the present invention either with or without a reactive diluent, for example a co-reactive monomer such as styrene.

The BPA-epoxy based vinyl ester resins provide handling properties similar to ambient temperature cure polyester systems but upon cure exhibit excellent physical properties similar to cured epoxy systems, thus combining the desired properties of these two different thermosetting resins into a single resin system.

Polyester resins may be co-cured with reactive diluent, such as styrene monomer, using a free radical initiator. The double bonds on the polyester backbone as well as the pendent double bond on the styrene monomer provide pathways for both chain extension and crosslinking.

### Reactive Diluent

Desirably, one or more reactive diluents may be used to reduce composition viscosity and may at least partially replace solvent. Generally, reactive diluent copolymerizes with resin during cure and is incorporated into the coating. The one or more reactive diluents may be monofunctional, multifunctional or a mixture thereof and monofunctional diluents may be selected to increase cured coating ductility while multifunctional diluents can be selected to increase cross-link density of the cured coating. In some embodiments, the reactive diluents are preferably one or more radical reactive diluents capable of participating in a radical polymerization reaction, non-limiting examples are compounds with ethylenic unsaturation. Representative examples include substituted and unsubstituted styrene, methyl methacrylate (MMA), and; mono-, di-, and poly-functional esters of unsaturated monofunctional acids (such as acrylic acid and methacrylic acid) with alcohols or polyols having from 1 to about 18 carbon atoms; and mono-, di-, and poly-functional esters of unsaturated monofunctional alcohols with carboxylic acids or their derivatives having from 1 to about 18 carbon atoms. Other suitable reactive diluents include, for example, acrylates, methacrylates, phthalates such as diallyl phthalate; triallylcyanurates; vinyl ethers; and the like.

Representative acrylates and methacrylate include butanediol dimethacrylate, trimethylolpropane trimethacrylate, ethylene dimethacrylate (EGDMA), polyethylene glycol dimethacrylate (PEGDMA), polypropylene glycol dimethacrylate (PPGDMA), trimethylol propane trimethacrylate (TMPTMA), tetramethylol propane trimethacrylate, dipropylene glycol dimethacrylate, isodecyl methacrylate, 1,3-butylene glycol dimethacrylate, 2-hydroxy ethyl methacrylate (2-HEMA), 1,6 hexane diol dimethacrylate (HDODMA), triethylene glycol dimethacrylate (TEGDMA), acetoacetoxyethyl methacrylate (AAEM) and the acrylate counterparts thereof.

Mixtures of reactive diluents may be used. Preferred reactive diluents include styrene, methyl methacrylate, TMPTMA, vinyltoluene, para-tertiary-butylstyrene, para-methylstyrene, EGDMA, 2-HEMA and mixtures thereof. The reactive diluent may for example represent about 5 to about 60 wt. %, about 10 to about 50 wt. %, or about 20 to about 40 wt. % of the coating composition.

### Thermally Conductive Boron Nitride Filler

The thermally conductive filler (c) comprises boron nitride, preferably hexagonal BN. Hexagonal boron nitride (“h-BN”) is an inert, lubricious ceramic material having a platy hexagonal crystalline structure, which is similar to that of graphite. In one embodiment, the invention relates to a mixture of at least two different boron nitride materials which provide synergistic effects, such as improved properties. The different boron nitride powder materials are selected from platelet morphology and non-platelet morphology. Non-platelet boron nitride is defined herein as any boron nitride other than platelet boron nitride. For example, non-boron nitride powder materials can include agglomerates of boron nitride that are made up of boron nitride platelets. The agglomerates of boron nitride powder materials can have spherical or irregular shape and vary in size from each other. Other non-platelet boron nitride powder materials include, but are not limited to, for example, partially crystalline boron nitride, amorphous boron nitride, and nano boron nitride powder materials having different properties including but not limited to surface areas, sizes, aspect ratios, densities. According to one embodiment, the two different boron nitride powder materials may be two different spherical agglomerates of boron nitride powder materials having different particle sizes.

To aid in reactant viscosity control, the thermally conductive ceramic particles may be of a certain particle size distribution and within a controlled aspect ratio range. The particle sieve size may accordingly be between 0.01-100 micrometers. In another embodiment, the thermally conductive ceramic particles may have a mean particle size of 0.01-100 micrometers, or between 1-25 micrometers. The particle aspect ratios for sphere, rod, or plate-shaped particles may preferably be between 1-50, or between 1-10.

In one embodiment, a form of the two different BN powder materials comprises crystalline or partially crystalline boron nitride particles made by processes known in the art, in either agglomerate boron nitride or platelet boron nitride forms. These may include spherical BN particles. In a preferred embodiment, the BN powder materials comprise platelets, preferably at least 50%, 60% or 70% platelets.

On one embodiment, particle size distribution with a D50 may be in a range from about 1, 1.2, 1.4, 1.6, 2.0, 2.5, 3.0, 3.5, 4.0, 4.5, or 5.0 micrometers to about 10.0, 9.5, 9.0, 8.5, 8.0, 7.5, 7.0, 6.5 or 6.0 micrometers. In another embodiment, the BN particles had a particle size distribution of D90 in a particle size range of 12-25, or 14-24, or 16-22 micrometers. Particle size distribution can be measured by laser light scattering, e.g. a Mastersizer 2000, dispersion in ethanol.

Surface area of the BN platelet powder materials desirably is less than 20 m2/g and may range in surface area as low as less than 3.0 m2/g. Preferably, surface area and aspect ratio are selected such that filler does not unduly increase viscosity and particles do not extend beyond the surface of the cured coating layer.

Optionally, the thermally conductive filler may include ceramic particles selected from a variety of non-hexagonal BN materials that afford the thermally conductive properties at the loading concentrations described herein. Examples of thermally conductive ceramic particle materials include alumina, aluminum nitride, boron nitride, beryllium oxide, zinc oxide, titanium dioxide, magnesium dioxide, and combinations thereof. Such particles impart both substantial thermal conductivity and enhance dielectric strength of the coatings of the present invention. Co-fillers such as alumina, alumina trihydrate (ATH) or calcium carbonate may be used in the coating composition to replace part of the boron nitride, provided that performance tests described herein are not unacceptably deteriorated.

### Wetting and Dispersing Agent

Compositions of the invention comprise wetting and dispersing agent, added to reduce agglomeration and settling of inorganic fillers in the coating composition, in particular BN and silica fillers.

An important performance criterion for the wetting and dispersing agent (d) is that it inhibits the thickening effect of inorganic fillers in the coating composition. Excessive thickening of the coating composition before it is applied to a substrate can negatively affect sprayability, cured coating surface roughness, and causes air retention voids in the coating. The wetting and dispersing agent (d) is a component which comprises one or more groups X with affinity to the filler and therefore can bind to the filler surface covalently, ionically, and/or by physisorption. The wetting dispersing agent also causes stabilization of the filler particles to prevent agglomeration, which leads otherwise to the sedimentation of the solids and hence a non-homogenous product. Responsible for this stabilization in general are one or more groups Y in the wetting and dispersing agent (d) which ensure compatibility with the surrounding medium.

Suitable wetting and dispersing agents (d) used are preferably wetting and dispersing agents (d) of relatively high molecular mass, more particularly polymeric wetting and dispersing agents (d). Suitable functional polymers preferably possess a number-average molecular weight (Mn) of at least 400 g/mol, preferably at least 800 g/mol, more preferably at least 2000 g/mol. The maximum molecular weight Mn is usefully 100 000 g/mol, preferably 50 000 g/mol, and more preferably 25 000 g/mol. In one embodiment the wetting and dispersing agent may be in a range of at least 2000 g/mol to 50 000 g/mol. The number-average molecular weights can be determined by gel permeation chromatography against a polystyrene standard.

The wetting and dispersing agent (d) used in accordance with the invention more particularly can be selected from linear or branched polymers and copolymers having compatibility with the surrounding medium and functional groups and/or groups with filler affinity. Examples of wetting and dispersing agents include alkylammonium salts of polymers and copolymers, polymers and copolymers having acidic groups, comb and block copolymers, such as block copolymers having, in particular, basic groups with filler affinity, optionally modified acrylate block copolymers, optionally modified polyurethanes, optionally modified and/or optionally salified polyamines, epoxide-amine adducts, phosphoric esters, especially those of polyethers, polyesters, and polyether-esters, basic or acidic ethoxylates such as alkoxylated monoamines or polyamines or acidic 1,2-dicarboxylic anhydride monoesters of alkoxylated monoalcohols, reaction products of unsaturated fatty acids with maleic anhydride and/or mono-, di-, and polyamines; as well as amino alcohols, and unsaturated 1,2-dicarboxylic acids and their anhydrides and their salts and reaction products with alcohols and/or amines; polymers and copolymers with fatty acid residues, optionally modified polyacrylates, such as transesterified polyacrylates, optionally modified polyesters, such as acid-functional and/or amino-functional polyesters, polyphosphates, and also mixtures of the foregoing.

Polymeric wetting and dispersing agents (d) based on polyisocyanates may be prepared by addition reaction of monohydroxy compounds, diisocyanate-functional compounds, and compounds having a tertiary amino group onto the existing NCO groups of polyisocyanates containing isocyanurate, biuret, urethane and/or allophanate groups. Amine based wetting and dispersing agents (d) which are obtainable by making an amine salt (salification) of an amine-functional compound with an acid may be used.

The following groups of wetting and dispersing agents (d) display particularly good effect in the compositions of the invention: (a) reaction products of unsaturated fatty acids with maleic anhydride and/or mono-, di-, and polyamines, amino alcohols, and (b) unsaturated 1,2-dicarboxylic acids and their anhydrides and their salts and reaction products with alcohols and/or amines, unsaturated polyamine amides and salts thereof and lower molecular weight acidic polyesters.

Wetting and dispersing agents (d) of these kinds are available as commercial products from, for example, BYK-Chemie from Wesel, under the trade names BYK-220 S, BYK-P 9908, BYK-9076, BYK-9077, BYK-P 104, BYK-P 104 S, BYK-P 105, BYK-W 9010, BYK-W 920, BYK-W 935, BYK-W 940, BYK-W 960, BYK-W 965, BYK-W 966, BYK-W 975, BYK-W 980, BYK-W 990, BYK-W 995, BYK-W 996, as well as trade name groups BYKUMEN, BYKJET, LACTIMON, ANTI-TERRA and DISPERBYK. Where the desire is for a low content of volatile organic compounds, especially of organic solvents, the aforementioned commercial products are desirably used as solvent-free active substances and preferably free of volatile constituents.

### Initiator

Initiators may be added to the curable liquid coating composition at the time of application to a surface as in mixing Part A and Part B in the spray gun. Alternatively, latent initiators that may be included in the curable liquid coating composition as supplied to the end user and are activated during the application process. Representative initiators include free-radical generators such as peroxides (e.g., benzoyl peroxide, methyl ethyl ketone peroxide (aka 2-butanone peroxide); cumene hydroperoxide, and the like), azoalkane catalysts and commercially available initiators or catalysts such as Luperox™ DDM9 and DHD9 catalyst (from Arkema), HIGH POINT™ 90 catalyst (from Chemtura) and CADOX™ L50a catalyst (from Akzo Nobel). Representative radiation activated or heat-activated initiators or catalysts include IRGACURE™ 819 initiator (from Ciba Specialty Chemicals) and cumene hydroperoxide. When used, the initiator or catalyst amount may for example be about 0.1 to about 5.0 wt. %, 0.2 to 4.0 wt. %, 0.5 to about 3.0 wt. %, about 1 to about 2.5 wt. %, or about 1.2 to about and 2 wt. % of the unsaturated polyester resin weight.

### Accelerator

Another component that may be present is one or more accelerators, different from the initiator. Representative accelerators for use in the curable liquid coating compositions are electron donating species that help in the decomposition of an initiator or catalyst and facilitate or speed curing of the curable liquid coating composition at relatively low temperatures, e.g., at temperatures of about 0 to about 30° C. Representative accelerators include metal compounds (e.g., cobalt, manganese, potassium, iron, vanadium, copper, and aluminum salts of organic acids); amines (e.g., dimethylaniline, diethylaniline, phenyl diethanolamine, dimethyl paratoluidine, and 2-aminopyridine); Lewis acids (e.g., boron fluoride dihydrate and ferric chloride); bases (e.g., tetramethyl ammonium hydroxide); quaternary ammonium salts (e.g., trimethyl benzyl ammonium chloride and tetrakismethylol phosphonium chloride); sulfur compounds (e.g., dodecyl mercaptan and 2-mercaptoethanol); dimethyl acetoacetamide; ethyl acetoacetate; methyl acetoacetate and mixtures thereof. For example, cobalt salts of organic acids may be used to facilitate the low temperature decomposition of peroxide catalysts and cure of the disclosed curable liquid coating compositions. Preferred accelerators include metal salts of organic acids, as disclosed above, in particular cobalt alkyloate salts, such as cobalt 2-ethylhexanoate cobalt octanoate, potassium octanoate, dimethyl acetoacetamide, ethyl acetoacetate, methyl acetoacetate and mixtures thereof. The accelerators typically are used in an amount of about 0.03 to about 3 wt. %, or about 0.05 to about 2 wt. %, 0.1 to about 1 wt. % of the curable liquid coating composition.

### Inhibitor

Another desirable component that may be present is an inhibitor. One or more inhibitors help prolong or maintain shelf life for the uncured curable liquid coating compositions by inhibiting premature polymerization. Suitable inhibitors may include free-radical inhibitors and/or scavengers such as quinones (e.g., hydroquinone (HQ), toluhydroquinone (THQ), mono-tertiarybutyl hydroquinone (MTBHQ), di tertiary-butyl hydroquinone (DTBHQ), napthaquinone (NQ), and monomethyl ether hydroquinone (MEHQ)), butylated hydroxy toluene (BHT), tertiary butyl catechol (TBC), and the like. The inhibitor may for example be present in an amount of from about 0.01 to about 0.5 wt. %, from about 0.01 to about 0.3 wt. % or from about 0.01 to about 0.1 wt. % of the curable liquid coating composition.

### Organic Solvent

An optional component of added organic solvent may be used to reduce viscosity of the coating composition. The added solvent, such as butyl acetate or acetone, is distinguished from incidental solvents included in raw materials and incorporated into coating composition with the raw materials. Examples of incidental solvents included with raw materials include mineral spirits, naphtha As used herein, solvent refers to chemicals that are removed during manufacture and not incorporated into the final product (other than trace amounts).

### Rheology Modifier

An optional component of rheology modifier may be used to control the viscosity characteristics and the body and hold-up characteristics of vinyl ester resins by imparting thixotropy to the vinyl ester resin composition. Suitable examples include modified and unmodified pyrogenic (fumed) amorphous silica or synthetic amorphous silica, desirably the silica may be basic or hydrophobically modified silica. In one embodiment the rheology modifier may be produced by combining an unsaturated polyester resin with a fumed silica. Desirably the rheology modifier is selected from those having one or more of the following attributes: a BET surface area of from 150 to 210 m2/g; a SiO₂ content of greater than or equal to 98.5 wt. %; and an NaO content of less than or equal to 0.5 wt. %. Rheology modifiers of these kinds are available as commercial products, for example, Cab-O-Sil M-5 (a fumed silica product manufactured by Cabot Corporation) and Aerosil® brand commercially available from Evonik Operations GmbH.

### Adhesion Promoter

An optional component of adhesion promoter may be included in the compositions of the invention to improve binding to metal substrates, e.g. cross-hatch adhesion performance, and resistance to humidity. Organosilane compounds may be used to promote adhesion, improve the strength and provide enhanced resistance to humid conditions. Other well-known adhesion promoters include organotitanates, organic chromium and zirconium complexes.

In some embodiments, adhesion promoters are used and may comprise silanes, such as epoxy, vinyl/acrylate/methacrylate functionalized silanes, such as Dynasylan products and some polyester based products, such as TEGO Addbond products both commercially available from Evonik Operations GmbH; as well as organo-phosphoric acids, such as HEMA-phosphates.

Examples of the silane coupling agent include, but are not limited to, aminosilanes such as γ-aminopropyltriethoxysilane, γ-aminopropyltrimethoxysilane, N-(aminoethyl)-Y-aminopropyltrimethoxysilane, N-(aminoethyl)-Y-aminopropyltrimethyl dimethoxysilane, and N-phenyl-Y-aminopropyltrimethoxysilane; epoxysilane such as -(3,4-epoxycyclohexyl)-ethyltrimethoxysilane, γ-glycidoxypropyltrimethoxy silane, and γ-glycidoxypropyltriethoxysilane; vinylsilane such as vinyl tris(-methoxyethoxy) silane, vinyltriethoxysilane, vinyltrimethoxysilane, and γ-methacryloxypropyltrimethoxysilane; hexamethyldisilazane; and γ-mercaptopropyltrimethoxysilane.

Examples of the titanate coupling agent include, but are not limited to, tetraisopropoxy titanium, tetra-n-butoxy titanium, butyl titanate dimer, tetrastearyl titanate, titanium acetylacetonate, titanium lactate, tetraoctyleneglycol titanate, titanium lactate, and tetra stearoxy titanium.

### Flexibilizer

An optional component of flexibilizer may be included in embodiments of the invention. Suitable examples of flexibilizer include methylmethacrylate-butadiene-styrene (MBS) and similar rubbers, one example being Clearstrength XT-100 commercially available from Arkema Inc.; polysulfide resins, such as Thioplast resins commercially available from Nouryon Chemicals LLC.

### Plasticizer

Optional plasticizers may be used in certain embodiments of the invention to increase flexibility and toughness of the cured dielectric coating. Increased toughness of the dielectric coating may reduce crazing and contribute to longer battery life, particularly in batteries used in moving vehicles. Examples of optional plasticizer include phthalates, benzoates, dibenzoates, phthalate esters, naphthalene sulfonate, trimellitates, adipates, sebacates, maleates, sulfonamides, organophosphates and polybutene.

### De-Aerator

Another component that may be present is one or more air release agents, so-called de-aerator. Air release agents may assist the curable liquid coating composition to release are before full cure thereby reducing entrapping of air and thereby causing weakness or porosity. Typical air release agents include silicone or non-silicone materials including a solution of polyalkylene ether and/or polyolefin in petroleum distillate, silicone de-aerators, acrylic polymers, hydrophobic solids, and mineral oil-based paraffin waxes. Commercially available air release agents include BYK-066, BYK-077, BYK-500, BYK-501, BYK-515, and BYK-555 de-aerators (from BYK-Chemie USA, Inc.). When used, the air release agent amount may for example be up to about 1.5 wt. %, up to about 1 wt. %, or from about 0.1 to about 0.5 wt. % of the curable liquid coating composition.

### Filler or Extender

In addition to the thermally conductive fillers of component (c), the curable liquid coatings may optionally comprise an extender filler, different from the thermally conductive fillers, such as clay, ground limestone, mica, talc, aluminum trihydrate, barium sulfate, precipitated silica, silica different from the rheology modifier and the like. Said extender fillers may also contribute to imparting thixotrophy to the curable liquid coatings of the invention. Even though it is emphasized, that curable liquid coating compositions of the invention, comprising a rheology modifier as disclosed above, can be produced without additional extender fillers without a decrease in their performance, it is nevertheless possible to add such additional fillers, if desired. These amounts of such fillers are not limited, although they are typically added in amounts of from about 5 to about 40 wt. % of the curable liquid coating composition.

In some embodiments where the cured liquid coatings of the invention may be in contact with moisture or aqueous materials in the use environment, the curable liquid coating compositions preferably are sufficiently free of extender filler susceptible to chemical or physical reaction with moisture or aqueous materials, e.g. swelling, dissolution or hydration and the like. In this manner, the cured coating will not exhibit blushing, delamination or failure after long-term contact with moisture or aqueous materials. Typical extender fillers in that case include chopped or milled fiberglass, talc, silicone dioxide, titanium dioxide, wollastonite, mica, alumina trihydrate, clay, calcium carbonate, magnesium carbonate, barium carbonate, calcium sulfate, magnesium sulfate and barium sulfate. While small amounts of water-susceptible extender filler may be tolerated, preferably no more than about 2 wt. %, and more preferably no more than about 1 wt. %, including no more than 0.8, 0.5, 0.3 and 0.1 wt. % water-susceptible extender filler is employed in the curable liquid coating composition.

### Other Additives

As described above the curable liquid coating composition may contain a number of other optional additives such as coupling agents, anti-foaming agents, pigments and dyes, plasticizers, flame retardants, chelate modified epoxy resins, auxiliary impact modifiers/toughening agents, fillers, flow control agents, antioxidants, non-reactive diluents, extenders or other adjuvants.

The curable liquid coating composition of the invention can comprise one or more additional thermal conductive fillers. Examples of the thermal conductive fillers include aluminum oxide (Al₂O₃), aluminum nitride (AlN), magnesium oxide (MgO), zinc oxide (ZnO), silicon nitride (Si₃N₄), aluminum powder and graphite and the like; any combination of these or similar thermally conductive fillers may be acceptable provided that they do not interfere unduly with the benefits of the dielectric thermally conductive nature of the invention. Different morphologies of filler having the same chemical composition may also be used, e.g. crystalline, nanotubes, sheets, amorphous etc. When the curable liquid coating composition comprises further thermal conductive fillers, the content of the thermal conductive fillers is 5 wt. % or more, preferably 10 wt. % or more, more preferably 15 wt. % or more based on the curable liquid coating composition. The content of the further thermal conductive fillers is 45 wt. % or less, preferably 35 wt. % or less, more preferably 25 wt. % or less based on the curable liquid coating composition.

Examples of flame retardant include antimony oxides, halocarbon, halogenated ester, halogenated ether, brominated flame retardant agent, and halogen free compounds such as organophosphorus compounds, organonitrogen compounds, intumescent flame retardants.

Examples of antioxidant include sodium sulfite, sodium pyrosulfite, sodium hydrogen sulfite, sodium thiosulfate and dibutyl phenol.

Examples of UV stabilizer include benzophenones, benzotriazoles, substituted acrylates, aryl esters and compounds containing nickel or cobalt salts.

Examples of coupling agent include chrome (III) compounds, silane coupling agent, titanate coupling agent, zirconium coupling agent, magnesium coupling agent and tin coupling agent.

Examples of pigment or dye include chromate, sulfate, silicate, borate, molybdate, phosphate, vanadate, cyanate, sulfide, azo pigment, phthalocyanine pigment, anthraquinone, indigo, quinacridone and dioxazine dyes. Various embodiments of the invention are described throughout this disclosure. In each of the embodiments described herein, the curable liquid coating composition is preferably a two-part coating composition where the two-parts are mixed together a sufficient time period before application or optionally are mixed together in a spray nozzle during or immediately prior to application. Preparation of two-part compositions is a conventional method of keeping reactive components of a composition from reacting prematurely. Customarily, Part A comprises resins and other components reactive with the initiator as well as suitable carriers, additives and adjuvants; and Part B comprises the initiator and any carriers or additives suitable for packaging with the initiator. It will be understood by those of skill in the art that the embodiments listing all components together describe both the Part A & B mixture as well as the two-part composition comprising Part A and Part B prior to their combination.

In some embodiments, the curable liquid organic-based coating composition may be a two-component composition comprising Parts A and B combined shortly before application. Accordingly, the invention extends to a two-part packaging providing separate reservoirs of Part A and Part B. Part A typically may comprise resin, solvent and additives and other components reactive with Part B at ambient temperature; while Part B generally comprises one or more initiators promoting reaction of the two Parts when combined, and may include other components reactive with Part A. As stated, Part A & Part B are mixed together to form the curable liquid coating compositions for deposition. This disclosure may also encompass one-part compositions, which provide at least some benefits of the invention, where reaction of combined components is prevented or slowed by known means, such as reversable blocking of the initiator, resin and/or accelerator.

Methods of depositing a layer of curable coating composition may include spraying, printing, dipping, Applicoater deposition, and other known processes. The curable liquid coating composition may, for example, be applied by conventional techniques over all article surfaces such that the part, e.g. a vehicle part or component, a cooling device and the like, is fully enveloped, by for example dipping or spraying, with spray-application being preferred for this use. Alternatively, the curable liquid coating composition can be applied onto specific portions of the part by any number of masking or printing methods known in the art. In some embodiments, the curable liquid coating composition desirably has viscosity suitable for spraying and/or printing, as well as zero solvent present or optionally low solvent content, which contributes to depositing thin coatings, free of voids providing complete substrate edge coverage by an uncured layer of as-deposited coating composition. The low solvent content may be, for example, in increasing order of preference, less than 50, 40, 30, 20, 15, 10, 8, 6, 4, 2 or 1 wt. %, more preferably the recited numerical values in grams/liter or mg/liter.

After optionally drying or solvent flash off, the uncured layer may be cured or may be transported and/or made part of an assembly followed by curing. The cured, preferably cross-linked composition, thereby forms a thermally conductive dielectric layer, typically in the form of a coating adhered to a substrate. Preferred curing methods are by heat and/or actinic radiation, e.g. UV, as described herein.

Deposition of the curable liquid organic-based coating compositions is capable of producing cured thin coatings free of voids having continuous coverage on substrate edges and providing good overall electrical insulation. The cured coatings may have thicknesses in a range of about 1.75, 2.0, 2.5 up to about 3.0, 3.5, 4 mils (meaning thousandths of an inch), i.e. about 40, 50, 65 up to about 75, 90 or 100 micrometers (also referred to herein as “μm” and “micron”). In comparison, cured UV and powder coatings require thicknesses of more than 5 mils (>127 μm) up to more than 10 mils (>254 μm) to provide void-free cured coatings, coverage of substrate edges with necessary coating thicknesses and no bare spots to achieve electrical insulation. Substrates comprising cured coatings according to the invention desirably show no visible edge effect, such as greater thickness at edges or picture frame effects, even at the lower coating thicknesses described above; these defects are commonly present in comparative coatings.

The cured dielectric coatings according to aspects of the invention, provide both rapid thermal dissipation and good electrical insulation with high dielectric strength, as measured and described herein. Rapid thermal dissipation is evaluated by testing thermal conductivity and thermal resistance of a cured coating. Cured dielectric coatings according to the invention exhibit high thermal conductivity and/or low thermal resistance as measured according to ASTM D5470 such that the cured coatings aid in heat dissipation. In some embodiments, cured dielectric coatings of the invention exhibit thermal conductivity of, in increasing order of preference, greater than about 0.25, 0.30, 0.35, 0.40, 0.45, 0.50 or 0.55 Watts per meter-Kelvin (W/mK).

Embodiments of the inventive cured dielectric coatings also exhibit low thermal resistance per mil of coating thickness, independently in increasing order of preference, in an amount of less than about 0.080, 0.077, 0.075, 0.074, 0.072, 0.070, 0.068, 0.066, 0.064, 0.062, 0.060, 0.059, 0.058, 0.057, 0.056, 0.055, 0.054, 0.053, 0.052, 0.051, 0.0515, 0.050, 0.049, 0.048, 0.047, 0.046, or 0.045 K/W per mil thickness of coating. In contrast, Comparative Example 1 had a thermal resistance of 0.191 K/W per mil thickness of coating, which is more than 2.5 times greater thermal resistance per mil than the most heat insulating inventive coating. Some embodiments according to the invention may have thermal resistance as low as 0.05, 0.06, 0.08, 0.16, 0.17 K/W at coating thicknesses in a range of about 1.1 to about 3 mils. Thicker inventive coatings, for example, had thermal resistance of 0.39 K/W at 7 mils and only 0.8 K/W at 10.8 mils thickness. In contrast, Comparative Example 1 was significantly more heat insulating, having thermal resistance of 1.13 K/W at 5.9 mils and 1.53 K/W at 8 mils thickness.

Electrical insulation for cured coatings of the invention is considered good where the coating conducts little, preferably no electricity, at a dielectric withstand voltage of greater than 2.0 kV, desirably greater than 3.0 kV, preferably greater than 4.0 kV, most preferably greater than 5 kV, as measured by a HypotMAX 7720 or an Ikonix 3865 and in accordance with ASTM D 149-09 Hipot test.

The cured dielectric coatings are useful in applications where heat dissipation and electrical insulation are required. The cured dielectric coatings find use in high energy density power generation or storage where significant heat can be generated during operation, such as in battery packs in cars or aircraft. The cured dielectric coatings, having both high dielectric strength and high thermal conductivity, are advantageous as electrical insulation in battery pack operation where efficient heat dissipation is critical to battery safety and longevity. The cured dielectric coating is also capable of providing additional protection against corrosion and abrasion during vehicle operation where environmental factors, e.g. water condensation, pollutants, vibration and the like, can damage underlying substrates.

The as-applied coating can be air dried, heat cured at relatively low temperatures, e.g. greater than ambient (meaning about 20-35° C.), or a combination thereof. For example, in some embodiments, cure may be in a range of about 10° C. to 130° C., preferably at least in increasing order of preference about 15, 20 or 25° C. and not more than in increasing order of preference about 130, 125, 120, 115, 110, 105, 100, 95, 90, 85, 80, 75, 70, 65, 60, 55, 50, 45, 40, 35, or 30° C., or various combinations of curing steps. In a preferred embodiment, the as-applied coating may be cured at temperatures in a range of ambient temperature up to about 65° C. providing a significant energy savings compared to typical curing temperatures of about 200° C. for powder coats. In some preferred embodiments, the as-applied coating may be subjected to combinations of curing steps, 1) a first curing step at the above-described temperatures for time periods ranging from 7-30 minutes and 2) a second curing step of heat treatment at temperatures, for example in a range of about 110 to 130° C. for time periods ranging from 7-30 minutes, still providing a significant energy savings compared to curing typical powder coats. Duration of curing can be adjusted to times sufficient to provide full cure of the coating, preferably total time for each cure step being at least in increasing order of preference about 1, 2, 3, 4, 5, 6, 7, 8, 9, or 10 minutes and not more than in increasing order of preference about 60, 55, 50, 45, 40, 35, 30, 25, 20 or 15 minutes.

### Void Testing:

Electrical insulative testing of a cured coating to reveal coating voids, which may include bare edges, pinholes and low thickness areas on substrates may be performed by “Hipot testing”, derived from the term High Potential Test. In Hipot testing, a high voltage is directly applied to a part having a cured coating under test. The test voltage is usually much higher than the ordinary operating voltage of the part in order to stress the dielectric properties of the coating under test. The test is designed to detect current leakage due to insulative cured coating defects, such as pin holes, cracks, voids and even low coating weight areas. Breakdown in the insulative coating results in current flowing across the test points of the Hipot tester, i.e. current leakage. Hipot testing of cured coatings according to the invention showed no voids, even around corners and edges of substrates coated which shows that edges are equally protected.

### Electrical Insulating Testing

Electrical insulation performance is confirmed as being “good”, that is permitting no flow of current through the test specimen using a high voltage test (“Hipot Test”) which detects flow of current upon application of a selected voltage for a specific time period. The “dielectric withstand voltage” being a voltage which a dielectric material (insulator) will withstand without current passing through the insulator, i.e. the greatest voltage at which little or no current flows (Passing test result). Desirably, electrical insulation properties of the cured dielectric coating according to the invention may exhibit a dielectric withstand voltage, in increasing order of preference, of greater than about 2.0, 2.5, 3.0, 3.5, 4.0, 4.2, 4.4, 4.5, 4.6, 4.7, 4.8, 4.9, 5.0, 5.1, 5.2, 5.3, 5.4 or 5.5 kV as measured in accordance with ASTM D 149-09 Hipot test. Alternatively, the dielectric withstand voltage may be increased in a stepwise fashion and the amount of current that the test sample permits to flow (also referred to as current leakage) recorded in microAmps (μA). Unaged cured coating layers according to the invention typically limit current leakage at 3.5 kV and 5.0 kv to as low as zero μA up to about 5.0. μA.

### Dielectric Strength

Dielectric Strength is a measure of the electrical strength of a material as an insulator. Dielectric strength is defined as the maximum voltage required to produce a dielectric breakdown through the material and is expressed as Volts per unit thickness. Breakdown is typically exhibited as an electrical burn-through puncture of the sample or insulator decomposition. A higher dielectric strength represents a better quality of insulator. The measurement enables performance comparisons between different materials used at different coating thicknesses. Desirably, the cured dielectric coating may exhibit a dielectric strength of, in increasing order of preference, greater than about 80, 90, 100, 120, 130, 140, 150 or 160 kV/mm thickness (e.g. approximately 1.5, 2, 2.5, 3.0, 3.5 or 4.0 kV/mil thickness).

Benefits of using the coating compositions of embodiments of the invention to form dielectric coatings may include, but are not limited to:
Easy preparation and application of the coating composition reduces special equipment costs and extra steps: for example, the inventive composition permits using standard or low shear mixing instead of high shear mixing; reducing or eliminating complex filler milling steps; simple application using, for example spray or print techniques; and optional shipping and handling of uncured coated substrates;
Single layer deposition provides thin coating with continuous edge coverage, in preferred embodiments avoiding multiple deposition steps, see Figures;
Efficient faster cure times are provided by embodiments of the invention as compared to known powder and other coatings. Times for curing via UV may range from about 2-200 seconds. Lower temperature bake less than 100° C., as described herein, may be for times ranging from 1 minute to 90 minutes, in particular 10, 30, 60 or 70 minutes. In some embodiments, the as-applied coating may be cured at ambient temperature or at temperatures in a range of about 20-65° C. providing a significant energy savings compared to typical curing temperatures of about 200° C. for powder coats
Cured dielectric coating provides greater than 2.0, 3.0, 3.5, 4.0, 4.5 or 5.0 kV electrical insulation and reduced heat retention;
Cured dielectric coatings exhibit high thermal conductivity and/or low thermal resistance as measured according to ASTM D5470 such that the cured coatings aid in heat dissipation. In some embodiments, cured dielectric coatings of the invention exhibit thermal conductivity of in increasing order of preference greater than about 0.25, 0.30, 0.35, 0.40, 0.45, 0.50 or 0.55 Watts per meter-Kelvin (W/mK)., which is significantly better than powder coats at 0.20 W/mK.

Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

The present invention is further defined in the following Examples. It will be understood that these examples, while indicating preferred embodiments of the invention, are given by way of illustration only, and should not be construed as limiting the appended claims. From the above discussion and these examples, one skilled in the art can ascertain the essential characteristics of this invention, and without departing from the spirit and scope thereof, can make various changes and modifications of the invention to adapt it to various usages and conditions. In particular, the following examples are intended to complement, rather than displace or supersede, the previous descriptions.

### EXAMPLES

The following Examples provide experimental methods used to make and test liquid coating compositions for depositing a thermally conductive dielectric coating on a substrate, their uncured properties & cured properties and performance. While each example disclosed in the specification is considered to provide specific individual embodiments of compositions, methods of preparation and use, none of the Examples is to be considered limiting of the more general embodiments described herein.

In the following examples, efforts have been made to ensure accuracy with respect to numbers used (e.g., amounts, temperature, etc.), but some experimental error and deviation should be accounted for. Unless indicated otherwise, temperature is in degrees C., ambient being about 22° C., and pressure is at or near atmospheric. No high shear mixing was required unless stated otherwise, below.

### Testing Methods:

Unless otherwise stated herein, liquid coating compositions of the examples were spray applied onto commercially available metal test panels and cured as described below. The cured dielectric coatings adhered to the metal test panels; dielectric coated test panels were tested according to the following standard test methods:
Dielectric withstanding voltage strength/HiPot test: ASTM D149-09
Thermal conductivity: ASTM D5470
Thermal resistance: ASTM D5470
Adhesion/cross-hatch: ASTM D3359.

### Example 1 Styrene-Containing Formula

The ingredients listed under Part A in Table 1 were added in sequence into a mixing vessel. The mixture was then mixed using a Planetary centrifugal mixer at 2000 RPM for 3 minutes to make Part A. Part B was then stirred into Part A for 1 minute and transferred to a HVLP Spray gun. Coatings of the composition of Table 1 were applied at different layer thicknesses on 6061 aluminum panels and baked in a 65° C. oven for 30 minutes producing cured coatings ranging in thickness from 2.8 mils to 8.0 mils (0.071 mm to 0.203 mm).

TABLE 1
Polyester/styrene Ex. 1 Formulation

| | | | Amount in |
|---|---|---|---|
| Component | | Reagent | wt. % |
| Part A | | Polyester resin with 43% Styrene | 67.94 |
| | | Methyl methacrylate | 4.60 |
| | Flexibilizer | Liquid polysulfide polymer with thiol end | 2.62 |
| | | groups (Mn: 2100-2700 g/mol) | |
| | Solvent | Butyl acetate | 9.2 |
| | Additives | Unsaturated acid polymer containing | 0.23 |
| | | polysiloxane copolymer (50% in mineral | |
| | | spirit) | |
| | De-aerator | Silicone-free polymer-based air release | 0.23 |
| | | additive foam-destroying polymer (7% in | |
| | | Naphtha) | |
| | Filler | Boron Nitride platelet (D90: 12-25 μm) | 13.11 |
| | Pigment | Pigment Orange 36 | 0.32 |
| | Rheology | Fumed silica (Surface area: 200 m²/g) | 1.38 |
| | modifier | | |
| Part B | Initiator | 2-Butanone peroxide (35% in TXIB*) | 0.37 |

*2,2,4-Trimethyl-1,3-pentanediol diisobutyrate

The 6061 aluminum panels with the cured dielectric coating of Example 1 on them were tested according to the test methods disclosed above, with the following results:
Thermal conductivity: the cured coated 6061 aluminum panels exhibited thermal conductivity of 0.56 Watts per meter-Kelvin (W/mK).
Thermal resistance: the cured coated 6061 aluminum panels exhibited thermal resistance of 0.16 Kelvins per watt (K/W) at cured coating thickness of 2.8 mils and 0.45 K/W at cured coating thickness of 7.9 mils.
Dielectric withstanding voltage: 6061 aluminum panels that had cured coating thickness at 4 mils (about 0.10 mm) and 8 mils (about 0.20 mm), respectively, withstood 5000 volts for 2 minutes.

### Example 2 Styrene-Free Formula

The ingredients listed under Part A in Table 2 were added in sequence into a mixing vessel. The mixture was then mixed using a Planetary centrifugal mixer at 2000 RPM for 3 minutes to make Part A. Part B was then stirred into Part A for 1 minute and transferred to a HVLP Spray gun. Coating layers of different thicknesses were applied on 6061 aluminum panels and baked in 65° C. oven for 30 minutes.

TABLE 2
Polyester/acrylate/BN without styrene Ex. 2 Formulation

| Component | | Reagent | Amount in wt. % |
|---|---|---|---|
| Part A | | Unsaturated polyester resin with 20% butyl | 43.25 |
| | | acetate | |
| | | Methyl methacrylate | 27.81 |
| | | Trimethylpropane triacrylate | 10.3 |
| | Solvent | Acetone | 0.94 |
| | Accelerator | Cobalt (II) 2 - ethylhexanoate (65 wt. % in | 0.09 |
| | | mineral spirit) | |
| | Additives | Unsaturated acid polymer containing | 0.26 |
| | | polysiloxane copolymer (50% in mineral | |
| | | spirit) | |
| | De-aerator | Silicone-free foam-destroying polymer (7% | 0.26 |
| | | in Naphtha) | |
| | Filler | Boron Nitride platelet (D90: 12-25 μm) | 14.68 |
| | Pigment | Pigment Orange 36 | 0.36 |
| | Rheology modifier | Fumed silica (Surface area: 200 m²/g) | 1.02 |
| Part B | Initiator | 2-Butanone peroxide (35% in TXIB) | 1.03 |

After baking, the dielectric coating of Example 2 was tested as described in Example 1, with the following results:

Dielectric withstanding voltage: 6061 aluminum panels that had coating thickness of 2.3 mils, 3.5 mils and 7.5 mils, respectively, withstood 5000 volts for 2 minutes. The coating had thermal conductivity of 0.54 W/mK, and thermal resistance of 0.17 K/W at 2.2 mils, 0.44 K/W at 6.3 mils and 0.80 K/W at 10.8 mils, respectively.

### Example 3 Styrene-Free Formula with Mixed Fillers

The ingredients listed under Part A in Table 3 were added in sequence into a mixing vessel. The mixture was then mixed using a Planetary centrifugal mixer at 2000 RPM for 3 minutes to make Part A. Part B was then stirred into Part A for 1 minute and transferred to a HVLP Spray gun. Coating layers of different thicknesses were applied on 6061 aluminum panels and baked in 65° C. oven for 30 minutes.

TABLE 3
Polyester/acrylate/BN/CaCO₃ without styrene Ex. 3 Formulation

| | | | Amount in |
|---|---|---|---|
| Component | | Reagent | wt. % |
| Part A | | Unsaturated polyester resin with 20% butyl | 35.45 |
| | | acetate | |
| | | Methyl methacrylate | 22.79 |
| | | Trimethylpropane triacrylate | 8.44 |
| | Solvent | Acetone | 0.94 |
| | Accelerator | Cobalt (II) 2 - ethylhexanoate (65 wt. % in | 0.09 |
| | | mineral spirit) | |
| | Additives | Unsaturated acid polymer containing | 0.26 |
| | | polysiloxane copolymer (50% in mineral | |
| | | spirit) | |
| | | Silicone-free polymer-based air release | 0.26 |
| | | additive foam-destroying polymer (7% in | |
| | | Naphtha) | |
| | Filler | Boron Nitride platelet (D90: 12-25 μm) | 14.68 |
| | | Calcium carbonate (Average PS: 1.4 μm) | 14.68 |
| | Pigment | Pigment Orange 36 | 0.36 |
| | Rheology modifier | Fumed silica (Surface area: 200 m²/g) | 1.02 |
| Part B | Initiator | 2-Butanone peroxide (35% in TXIB) | 1.03 |

After baking, the dielectric coating of Example 3 was tested as described in Example 1, with the following results: The coating had thermal conductivity of 0.70 W/mK, and thermal resistance of 0.23 K/W at 4.1 mils, 0.39 K/W at 7.0 mils and 0.53 K/W at 9.3 mils.

Dielectric withstanding voltage: 6061 aluminum panels that had coating thickness of 4.0 mils withstood 5000 volts for 2 minutes.

### Example 4 (Comparative Example): Comparative Example No. 1

The ingredients listed under Part A in Table 4 were added in sequence into a mixing vessel. The mixture was then mixed using a Planetary centrifugal mixer at 2000 RPM for 3 minutes to make Part A. Part B was then stirred into Part A for 1 minute and transferred to a HVLP Spray gun. Coating layers of different thicknesses were applied on 6061 aluminum panels and baked in 65° C. oven for 30 minutes.

TABLE 4
Formulation of Comparative Example 1 Styrene-free formula with alumina filler

| | | | Amount in |
|---|---|---|---|
| Component | | Reagent | wt. % |
| Part A | | Unsaturated polyester resin with 20% | 43.25 |
| | | butyl acetate | |
| | | Methyl methacrylate | 27.81 |
| | | Trimethylpropane triacrylate | 10.3 |
| | Solvent | Acetone | 0.94 |
| | Accelerator | Cobalt (II) 2 - ethylhexanoate (65 wt. % in | 0.09 |
| | | mineral spirit) | |
| | Additives | Unsaturated acid polymer containing | 0.26 |
| | | polysiloxane copolymer (50% in mineral | |
| | | spirit) | |
| | | Silicone-free foam-destroying polymer | 0.26 |
| | | (7% in Naphtha) | |
| | | Anti-foaming agent | |
| | Filler | Alumina particles (SSA: 0.6 m²/g; D50: 3 | 14.68 |
| | | μm) | |
| | Pigment | Pigment Orange 36 | 0.36 |
| | Rheology modifier | Fumed silica (Surface area: 200 m²/g) | 1.02 |
| Part B | Initiator | 2-Butanone peroxide (35% in TXIB) | 1.03 |

After baking, the dielectric coating of Comparative Example 1 was tested as described in Example 1, with the following results: The coating had thermal conductivity of 0.21 W/mK, and thermal resistance of 0.67 K/W at 3.5 mils, 1.13 K/W at 5.9 mils and 1.53 K/W at 8.0 mils.

Dielectric withstanding voltage: 6061 aluminum panels that had coating thickness of 2.5 mils failed to withstand 3500 volts, while coatings of 4.5 mils and 8.5 mils thickness delaminated from the panels (catastrophic failure).

### Example 5 Styrene-Containing Formula with Mixed Resin System

The ingredients listed under Part A in Table 5 were added in sequence into a mixing vessel. The mixture was then stirred on a magnetic stir plate at 600 RPM for overnight to make Part A. Part B was then stirred into Part A for 1 minute and transferred to a HVLP Spray gun. Coating layers of different thicknesses were applied on 5052 aluminum panels and baked in 65° C. oven for 30 minutes followed by 30 minutes at 125° C.

TABLE 5
Epoxy/styrene/acrylate/BN Ex. 5 Formulation

| Component | | Reagent | Amount in wt. % |
|---|---|---|---|
| Part A | | Epoxy vinyl ester resin* in | 32.92 |
| | | 45% styrene | |
| | | Modified Bisphenol A epoxy diacrylate | 19.75 |
| | | Styrene | 13.17 |
| | | Methyl methacrylate | 4.45 |
| | Solvent | Butyl acetate | 9.54 |
| | Accelerator | Cobalt (II) 2 - ethylhexanoate (65 wt. % in | 0.06 |
| | | mineral spirit) | |
| | Additives | Unsaturated acid polymer containing | 0.89 |
| | | polysiloxane copolymer (50% in mineral | |
| | | spirit) | |
| | | Silicone-free polymer-based air release | 0.44 |
| | | additive foam-destroying polymer (about | |
| | | 39% in Naphtha) | |
| | | Anti-foaming agent | 0.89 |
| | Filler | Boron Nitride platelet (D90: 12-25 μm) | 14.06 |
| | Pigment | Pigment Orange 36 | 0.27 |
| | Adhesion Promoter | Bifunctional organosilane | 1.78 |
| Part B | Initiator | 2-Butanone peroxide (35% in TXIB) | 1.78 |

*described by manufacturer as containing a small amount of catalyst primer.

After baking, the dielectric coating of Example 5 was tested as described in Example 1, with the following results: The coating had thermal conductivity of 0.61 W/mK, and thermal resistance of 0.06 K/W at 1.2 mils, 0.08 K/W at 1.6 mils and 0.23 K/W at 4.3 mils. Dielectric withstanding voltage: 5052 aluminum panels that had coating thickness of 2.1, 3.2 and 4.5 mils, respectively each withstood 3500 volt testing for 2 min and 5000 volts testing for 2 min with leakage current from 0.0 to 0.1 μA.

Humidity Age Testing: The coated panels were age tested in a Thermotron chamber maintained at 85° C. with 85% relative humidity for 1,000 hrs. After aging, the coated panels were tested for crosshatch adhesion and dielectric withstanding voltage according to the test methods disclosed above, with the following results: All aged, coated panels maintained crosshatch adhesion and passed the dielectric withstand test at 5000 volts for 2 minutes with leakage current from 0.7 to 2.0 μA.

Another sample of the Example 5 composition was applied to an aluminum 3003 prismatic battery box and baked in 65° C. oven for 30 minutes followed by 10 minutes at 125° C. and fully cured in the shorter time. A painted aluminum panel from the coated battery cell can was prepared for metallurgical cross-sectional analysis per AM 530. Equipment/Method Utilized was Hitachi SU5000 Field Emission Scanning Electron Microscope with EDAX Energy Dispersive X-AM 530. Cross-section sample preparation: Parts were mounted in epoxy with conductive filler. The epoxy mounted cut panels were ground and polished using the Beuhler Beta Grinder-Polisher following Analytical Method A-530. The epoxy mounts were mounted to an aluminum stage with copper tape and examined by SEM/EDS at 15 keV in low vacuum mode using the backscatter electron detector.

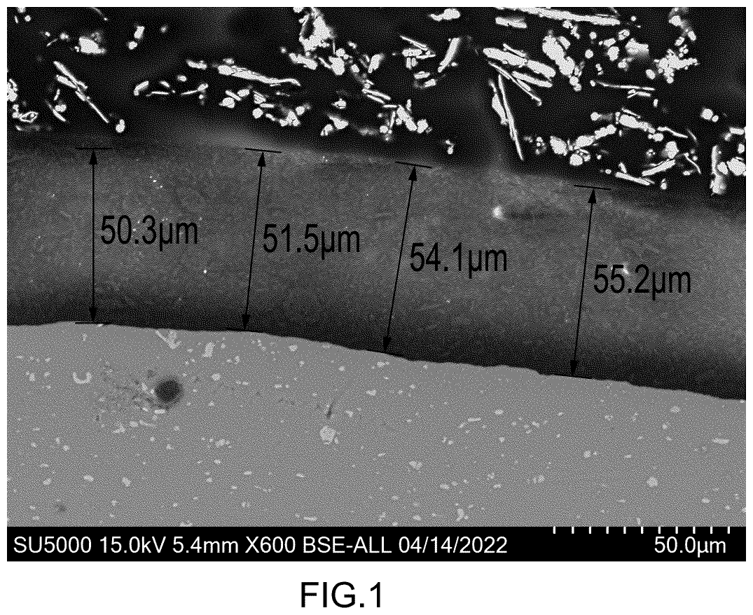

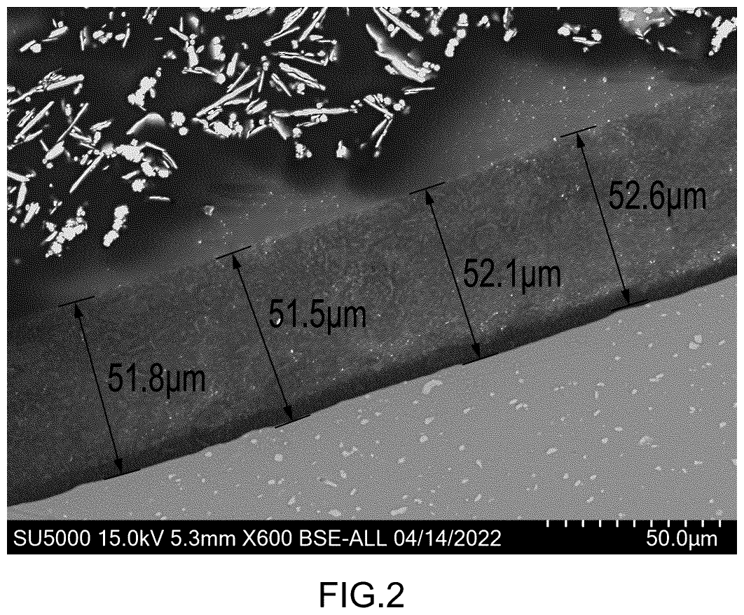

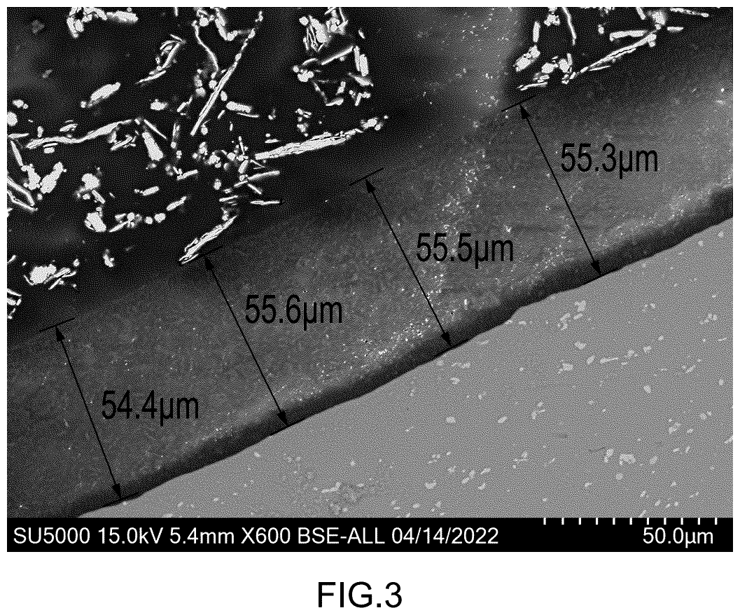

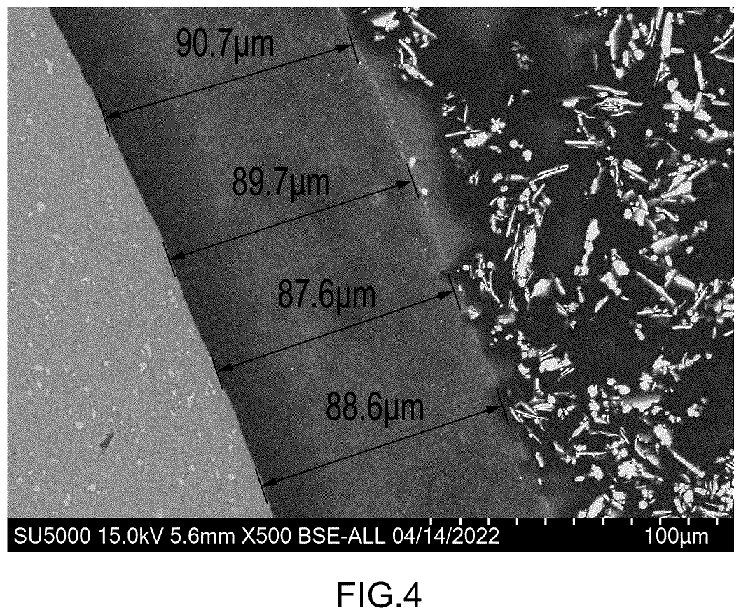

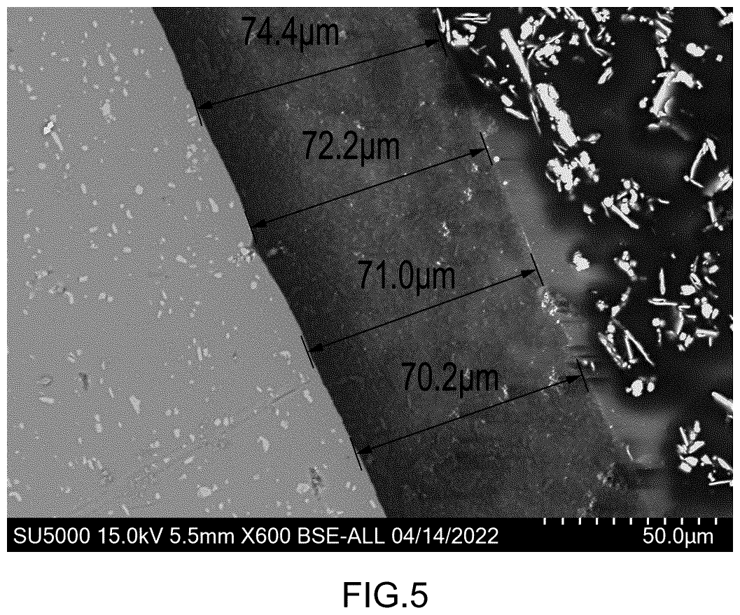

FESEM imaging was done on the corner and on both edges of the panel distant from the corners in 2 areas, End and Middle and the thickness of the coating was measured, see Table 5a and FIGS. 1-5.

TABLE 5a
FESEM measurements of coating thickness Ex. 5 Formulation

| Panel Area Measured | Coating Thickness (μm) |
|---|---|
| Corner | 52.8 |
| Left Edge-End | 52.0 |
| Left Edge-Middle | 55.2 |
| Right Edge-End | 89.6 |
| Right Edge-Middle | 72.0 |

FESEM imaging showed that one side had coating thicknesses similar to the corner while the other side had thicknesses thicker than the corner. The FESEM coating thickness showed excellent edge coverage and acceptable variation in thickness with adequate cure of the coating.

### Example 6 Styrene-Containing Formula with Mixed Resin System and Different BN Filler

The ingredients listed under Part A in Table 6 were added in sequence into a mixing vessel. The mixture was then stirred on a magnetic stir plate at 600 RPM for overnight to make Part A. Part B was then stirred into Part A for 1 minute and transferred to a HVLP Spray gun. Coating layers of different thicknesses were applied on 5052 aluminum panels and baked in 65° C. oven for 30 minutes followed by 30 minutes at 125° C.

TABLE 6
Epoxy/acrylate/styrene with different BN particles Ex. 6 Formulation

| | | | Amount in |
|---|---|---|---|
| Component | | Reagent | wt. % |
| Part A | | Diacrylate ester of a Bisphenol A epoxy | 19.75 |
| | | resin | |
| | | Modified Bisphenol A epoxy diacrylate | 19.75 |
| | | Styrene: | 26.34 |
| | | Methyl methacrylate | 4.45 |
| | Solvent | Butyl acetate | 9.54 |
| | Accelerator | Cobalt (II) 2 - ethylhexanoate (65 wt. % in | 0.06 |
| | | mineral spirit) | |
| | Additives | Unsaturated acid polymer containing | 0.89 |
| | | polysiloxane copolymer (50% in mineral | |
| | | spirit) | |
| | | Silicone-free polymer-based air release | 0.44 |
| | | additive foam-destroying polymer (about | |
| | | 39% in Naphtha) | |
| | | Anti-foaming agent | 0.89 |
| | Filler | Boron Nitride platelet (D50: 5 μm) | 14.06 |
| | Pigment | Pigment Orange 36 | 0.27 |
| | Adhesion | Bifunctional organosilane | 1.78 |
| | Promoter | | |
| Part B | Initiator | 2-Butanone peroxide (35% in TXIB) | 1.78 |

After baking, the dielectric coating of Example 6 was tested as described in Example 1, with the following results: The coating had thermal conductivity of 0.60 W/mK, and thermal resistance of 0.08 K/W at 1.5 mils, 0.21 K/W at 4.0 mils and 0.28 K/W at 5.2 mils. Dielectric withstanding voltage: 5052 aluminum panels that had coating thickness of 2.5 and 4.0 mils, respectively each withstood 3500 volt testing for 2 min and 5000 volts testing for 2 min with leakage current from of 0.1 and 0.0 μA.

Humidity Age Testing: The coated panels were age tested in a Thermotron chamber maintained at 85° C. with 85% relative humidity for 1,000 hrs. After aging, the coated panels were tested for crosshatch adhesion and dielectric withstanding voltage according to the test methods disclosed above, with the following results: All aged, coated panels maintained crosshatch adhesion and passed the dielectric withstand test at 5000 volts for 2 minutes with leakage current of 9.8 and 5.1 μA separately.

### Example 7 Styrene-Containing Formula on Pretreated Substrates

The ingredients listed under Part A in Table 7 were added in sequence into a mixing vessel. The mixture was then stirred on a magnetic stir plate at 600 RPM overnight to make Part A. Part B was then stirred into Part A for 1 minute and the combination was transferred to a HVLP Spray gun.

TABLE 7
Epoxy/styrene/acrylate/BN Ex. 7 Formulation

| | | | Amount in |
|---|---|---|---|
| Component | | Reagent | wt. % |
| Part A | | Epoxy vinyl ester resin* in 48% styrene (primed) | 32.92 |
| | | Modified Bisphenol A epoxy diacrylate | 19.75 |
| | | Styrene: | 13.17 |
| | | Methyl methacrylate | 4.45 |
| | Solvent | Butyl acetate | 9.55 |
| | Accelerator | Cobalt (II) 2 - ethylhexanoate (65 wt. % in mineral | 0.05 |
| | | spirit) | |
| | Additives | Unsaturated acid polymer containing polysiloxane | 0.89 |
| | | copolymer (50% in mineral spirit) | |
| | | Silicone-free polymer-based air release additive foam- | 0.44 |
| | | destroying polymer (about 39% in Naphtha) | |
| | | Anti-foaming agent | 0.89 |
| | Filler | Boron Nitride platelet (D90: 12-25 μm) | 14.06 |
| | Pigment | Pigment Orange 36 | 0.27 |
| | Adhesion | Bifunctional organosilane | 1.78 |
| | Promoter | | |
| Part B | Initiator | 2-Butanone peroxide (35% in TXIB) | 1.78 |

*described by manufacturer as containing a small amount of catalyst primer.

In this example, Aluminum 5052 metal substrate panels were pre-treated according to procedures as set forth in Table 8, below, prior to coating with the liquid dielectric coating composition of Ex. 7. Bonderite C-AK 6849 is aqueous alkaline cleaner commercially available from Henkel Corp. Bonderite C—IC SmutGo NC is an acidic deoxidizer commercially available from Henkel Corp. Bonderite M-NT 5200 organic/inorganic conversion coating commercially available from Henkel Corp.

TABLE 8
Pretreatment Test Process for Aluminum Substrates of Ex. 7

| Pretreatment Process A | | Pretreatment Process B* | |
|---|---|---|---|
| 1. | Bonderite C-AK 6849 - 20%, | 1. | Bonderite C-AK 6849 - 20%, 60° C. (140° F.), 3 mins. |
| | 60° C. (140° F.), 3 mins. | 2. | Water rinse - 3 mins. |
| 2. | Water rinse - 3 mins. | 3. | Bonderite C - IC SmutGo NC - 3 mins., ambient |
| | | 4. | Water rinse - 3 mins. |
| | | 5. | Bonderite M-NT 5200 - 3.1%, pH 3.1, 1.5 mins., |
| | | | ambient (Coating weights: ~25 mg/ft²) |
| | | 6. | Water rinse - 3 mins. |

Aluminum 5052 panels which had been pretreated according to Pretreatment Process A or Pretreatment Process B, as shown in Table 8, were coated with the composition of Table 7 in differing amounts using the HVLP Spray gun and then baked in 65° C. oven for 30 minutes followed by 30 minutes at 125° C., producing dielectric coatings having various film thicknesses as shown in Table 9.

After baking, the dielectric coating of Example 7 adhered to the pretreated substrates was tested as described in Example 1, and exhibited test results as shown in Table 9:

TABLE 9
Unaged Testing of Cured Dielectric Coating of Ex. 7 on Pretreated Substrates

| Ex. 7 Cured | Dielectric | | | Dielectric | Thermal |
|---|---|---|---|---|---|
| Dielectric | Thickness | Crosshatch | Dielectric | 5.0 kV (le [symbol] | Conductivity |
| Coating | (mils) | % remaining | 3.5 kV | current in μA) | W/mK |
| Pretreatment | 1.7 | 100 | P | P (0.0) | 0.567 |
| Process A | 4.0 | 100 | P | P (0.0) | |
| | 6.2 | 100 | P | P (0.0) | |
| Pretreatment | 1.7 | 100 | P | P (0.0) | 0.568 |
| Process B | 4.4 | 100 | P | P (0.0) | |
| | 6.8 | 100 | P | P (0.0) | |

[symbol]

indicates data missing or illegible when filed

The coated panels of Table 9 were then humidity aged in a Thermotron chamber maintained at 85° C. with 85% relative humidity for 1,000 hrs. After humidity aging, the coated panels were tested for crosshatch adhesion and dielectric withstanding voltage at 5000 volts, according to the test methods disclosed above, with the results as shown in Table 10. All aged, coated panels maintained crosshatch adhesion and passed the dielectric withstand test at 5000 volts for 2 minutes with leakage current of 8.1 to 1.1 μA.

TABLE 10
Humidity Age Testing of Cured Dielectric
Coating of Ex. 7 on Pretreated Substrates

| Ex. 7 Cured | Dielectric Film | | | Leakage |
|---|---|---|---|---|
| Dielectric | Thickness | Crosshatch | Dielectric | current |
| Coating | (mils) | % remaining | 5.0 kV | (μA) |
| Pre-treatment | 1.7 | 100 | P | 8.1 |
| Process A | 4.0 | 100 | P | 1.5 |
| | 6.2 | 100 | P | 1.1 |
| Pre-treatment | 1.7 | 100 | P | 2.4 |
| Process B | 4.4 | 100 | P | 2.7 |
| | 6.8 | 100 | P | 5.0 |

Subsequent testing of secondary cure of shorter duration for the above examples showed that 10-30 minutes secondary cure produced acceptable results. The above exemplary embodiments show that the inventive coating compositions are useful for forming void-free, thin coatings with continuous coverage on substrate edges, and provide both quick thermal dissipation and good electrical insulation with high dielectric strength. Therefore, the cured coatings offer great advantages in applications where high energy density power generation or storage with significant heat being generated during operation such as the battery packs in vehicles, such as cars or aircraft. The coating can provide further protection against battery damage during the vehicle operation where water condensation and constant vibration are common sources of corrosion and abrasion. The coating can be air dried or baked to cure as described above and may be further cured with UV light in a dual cure manner.

1. A curable liquid coating composition useful in forming a heat dissipating, dielectric coating comprising components of:
(a) a polyester resin;
(b) a reactive diluent;
(c) a thermally conductive filler;
(d) a dispersing agent;
(e) an initiator; and
(f) optionally an accelerator, different from the initiator;
wherein the polyester resin (a) is selected from unsaturated polyester resins, optionally comprising vinyl ester resins, including epoxy acrylate esters and epoxy methacrylate esters, and combinations thereof.

2. The curable liquid coating composition of claim 1 wherein said components comprise, in wt. %:
(a) an unsaturated polyester resin, comprising epoxy acrylate esters and epoxy methacrylate esters, and combinations thereof, present in a range of from about 10% to about 95%;
(b) a radical reactive diluent, present in a range of from about 10% to about 95%;
(c) a thermally conductive filler optionally comprising boron nitride, alumina, aluminum trihydrate, present in a range of from about 5% to about 50%;
(d) a dispersing agent optionally present in a range of from about 0.1% to about 2.0%;
(e) an initiator;
(f) an accelerator, different from the initiator;
(g) an organic solvent optionally present in a range of from about 0.5% to about 20%;
(h) at least one additive selected from a rheology modifier, an adhesion promoter, a flexibilizer, and a plasticizer;
(i) a de-aerator and/or an anti-foaming agent;
wherein the wt. % of each component is relative to the total weight of the composition and the total amount of the components does not exceed 100 wt. %.

3. The curable liquid coating composition of claim 1, wherein component (a) the unsaturated polyester resins comprising vinyl ester resins, optionally including epoxy acrylate esters and epoxy methacrylate esters, and combinations thereof is present in a range of from about 10 wt. % to about 95 wt. %, relative to the total weight of the composition.

4. The curable liquid coating composition of claim 1, wherein component (b) the radical reactive diluent, is present in a range of from about 10 wt. % to about 95 wt. %, relative to the total weight of the composition.

5. The curable liquid coating composition of claim 1, wherein component (c) the thermally conductive filler, is present in a range of from about 5 wt. % to about 50 wt. %, relative to the total weight of the composition.

6. The curable liquid coating composition of claim 1, wherein component (d) the dispersing agent, is present in a range of from about 0.2 wt. % to about 1.9 wt. %, relative to the total weight of the composition.

7. The curable liquid coating composition claim 1, wherein component (e) the initiator, is present in a range of from about 0.1 wt. % to about 5.0 wt. %, relative to the total weight of the composition.

8. The curable liquid coating composition of claim 1, wherein component (f) the accelerator different from the initiator, is present in a range of from about 0.05 wt. % to about 1.0 wt. %, relative to the total weight of the composition.

9. The curable liquid coating composition of claim 1, wherein component (g) the organic solvent, is present in a range of from about 1 wt. % to about 20 wt. %, relative to the total weight of the composition.

10. The curable liquid coating composition of claim 1, wherein component (h) the additive, is present in an amount ranging from in a range of from about 0.1 wt. % to about 5.0 wt. %, relative to the total weight of the composition.

11. The curable liquid coating composition of claim 10, wherein the additive comprises the rheology modifier present in a range of from about 0.1 wt. % to about 5 wt. %, relative to the total weight of the composition.

12. The curable liquid coating composition of claim 1, wherein the flexibilizer is present in a range of from about 0.1 wt. % to about 5 wt. %, relative to the total weight of the composition.

13. The curable liquid coating composition of claim 1, wherein the plasticizer, is present in a range of from about 0.1 wt. % to about 5.0 wt. %, relative to the total weight of the composition.

14. The curable liquid coating composition of claim 1, wherein component (i) the de-aerator and/or an anti-foaming agent, are each present in a range of from about 0.1 wt. % to about 2.0 wt. %, relative to the total weight of the composition.

15. The curable liquid coating composition of claim 1, wherein component (a) comprises a mixture of two different unsaturated polyester resins comprising epoxy vinyl ester resins; and component (c) the thermally conductive filler, comprises platelet morphology boron nitride, at least a portion of the boron nitride being hexagonal BN.

16. The curable liquid coating composition of claim 1, wherein component (a) comprises a mixture of unsaturated polyester resin, methyl methacrylate and a triacrylate; component (e) the initiator comprises a peroxide; the accelerator is present comprising a cobalt composition; and component (h) the at least one additive is present as a fumed silica rheology modifier and a siloxane adhesion promoter.

17. The curable liquid coating composition of claim 1, wherein component (c) the thermally conductive filler, comprises hexagonal BN; the composition further comprising calcium carbonate extender filler.

18. A cured dielectric, heat dissipating coating layer deposited on a metal surface comprising a cured coating layer formed by contacting the metal surface with a curable liquid coating composition according to claim 1 and drying the composition on the metal surface, wherein the cured coating layer has a thermal resistance per mil of coating thickness, of less than about 0.080 K/W.

19. The cured dielectric, heat dissipating coating layer according to claim 18 further comprising a conversion coating layer interposed between the metal surface and the cured dielectric, heat dissipating coating layer.

20. The cured dielectric, heat dissipating coating layer according to claim 18, having a dielectric strength of greater than about 80 kV/mm thickness of the coating layer.

21. The cured dielectric, heat dissipating coating layer according to claim 18 having a thickness in a range of about 40 micrometers to about 100 micrometers.

22. A method for increasing heat dissipation and electrical insulation of a surface of a metal substrate, comprising steps of:
contacting, optionally, immersing and/or spraying a surface of a metal substrate, with the curable liquid coating composition according to claim 1; and
drying the composition in place, optionally at temperatures in a range of about 10° C. to about 100° C., thereby forming a cured dielectric, heat dissipating coating layer adhered to the metal substrate.

23. The method according to claim 22, further comprising applying a conversion coating to the surface of the metal substrate prior to contacting the metal substrate with the curable liquid coating composition, such that the cured dielectric, heat dissipating coating layer is adhered to the conversion coating deposited on the metal substrate.

24. The method according to claim 22, wherein the surface of the metal substrate coated with the cured dielectric, heat dissipating coating layer exhibits a dielectric strength of greater than about 90 k V/mm thickness.

25. A metal container comprising a surface having disposed thereon a layer of the curable liquid coating composition according to claim 1.

26. The metal container according to claim 25, wherein a cured dielectric, heat dissipating coating layer formed from the curable liquid coating composition disposed on the surface of the metal container has a thermal conductivity of greater than about 0.25 Watts per meter-Kelvin (W/mK).
